(19) United States
(12) Patent Application Publication
(10) Pub. No.: US 2009/0324257 A1
(43) Pub. Date: Dec. 31, 2009

(54) OPTICAL TRANSMISSION APPARATUS, OPTICAL TRANSMISSION SYSTEM AND COMMUNICATION METHOD THEREIN

(75) Inventors: Makoto MURAKAMI, Kawasaki (JP); Toshihiro Ohtani, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/491,365

(22) Filed: Jun. 25, 2009

(30) Foreign Application Priority Data
Jun. 30, 2008 (JP) 2008-171358

(51) Int. Cl. H04B 10/12

(52) U.S. Cl. 398/200

(57) ABSTRACT

An optical transmitting station changes a power level of control signal light having a first frequency at a second frequency lower than the first frequency, and transmits the control signal light whose power level has been changed to an optical receiving station through an optical transmission line. The optical receiving station monitors whether signal light components of the second frequency are received through the optical transmission line.

### CROSS-REFERENCE TO RELATED APPLICATION

This application is based upon and claims the benefit of priority of the prior Japanese Application No. 2008-171358 filed on Jun. 30, 2008 in Japan, the entire contents of which are hereby incorporated by reference.

### FIELD

The embodiments discussed herein are related to an optical transmission apparatus, an optical transmission system and a communication method in the optical transmission system.

### BACKGROUND

There is Wavelength Division Multiplexing (WDM) as one of the optical transmission systems.

For example, a transmission apparatus used for a transmission system in such the WDM system can transmit signal light over a long distance as it remains intact by the use of an optical amplifier without performing optoelectric conversion.

For example, long distance transmission is possible disposing an erbium doped fiber amplifiers (EDFA) in a transmitting/receiving station or, in one or more repeating stations which act as the optical transmission apparatus.

Longer-distance transmission is made possible with the combined use of an EDFA and a Raman amplifier. A Raman amplifier (Raman pumping source) can be placed in a receiving station in each transmission section, for example, to amplify signal light transmitted through an optical transmission line with the use of stimulated Raman scattering phenomenon in the optical transmission line.

In such an optical transmission system, a wavelength outside a transmission bandwidth of the main signal light such as a wavelength (channel) on the shorter wavelength's side is sometimes used as light for transmitting an optical supervisory channel (OSC, supervisory control), in order to transmit/receive information about control, monitoring, alarm and the like between the optical transmission apparatuses.

Meanwhile, documents below shows known examples related to the optical transmission system:

[Patent Document 1] Japanese Laid-Open Patent Publication No. H04-258035

[Patent Document 2] Japanese Laid-Open Patent Publication No. 2000-332331

In such the transmission system, the OSC signal sometimes cannot reach the receiving station in a long-distance optical transmission section (that is, the OSC communication cannot be established), hence controls such as an apparatus starting control and the like become impossible.

### SUMMARY

According to an aspect of the embodiment, an apparatus includes an optical transmission apparatus transmitting signal light through an optical transmission line to an optical reception apparatus, the optical transmission apparatus including a transmitter that transmits control signal light having a first frequency to the optical transmission line; and a controller that changes a power level of the control signal light at a second frequency lower than the first frequency.

According to another aspect of the embodiment, an apparatus includes an optical reception apparatus receiving signal light from an optical transmission apparatus through an optical transmission line, the optical reception apparatus including a receiver that receives the signal light regenerated by changing a power level of control signal light having a first frequency at a second frequency lower than the first frequency in the optical transmission apparatus and transmitted from the optical transmission apparatus, and a monitor that monitors whether signal light components of the second frequency are received by the receiver.

According to still another aspect of the embodiment, a system includes an optical transmission system including an optical transmission apparatus that transmits signal light through an optical transmission line, an optical reception apparatus that receives the signal light from the optical transmission apparatus through the optical transmission line, a transmitter that transmits control signal light having a first frequency to the optical transmission line, a controller that changes a power level of the control signal light at a second frequency lower than the first frequency, a receiver that receives the control signal light transmitted from the optical transmission apparatus, and a monitor that monitors whether signal light components of the second frequency are received by the receiver.

According to still another aspect of the embodiment, a method includes a communication method in an optical transmission system including an optical transmission apparatus, an optical reception apparatus and an optical transmission line connecting the optical transmission apparatus to the optical reception apparatus, the method including changing a power level of control signal light having a first frequency at a second frequency lower than the first frequency in the optical transmission apparatus, transmitting the control signal light whose power level has been changed to the optical reception apparatus from the optical transmission apparatus through the optical transmission line, and monitoring in the optical reception apparatus whether signal light components of the second frequency are received from the optical transmission line.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWING(S)

FIG. 1 is a block diagram illustrating an example of configuration of a transmission system according to an embodiment;

FIG. 2 is a diagram illustrating a driving current-gain characteristic of an SOA;

FIG. 3 is a diagram illustrating a relationship between an OSC signal and an apparatus starting signal;

FIG. 4 is a diagram illustrating a relationship between a clock of the apparatus starting signal and a clock for ADC sampling;

FIG. 5 is a flowchart for illustrating an example of operation of the transmission system in FIG. 1;

FIG. 6 is a block diagram illustrating another example of the configuration of the transmission system according to the embodiment;

FIG. 7 is a block diagram illustrating still another example of the configuration of the transmission system according to the embodiment;

FIG. 8 is a diagram illustrating an input optical power-output optical power characteristic of the SOA;

FIG. 9 is a flowchart illustrating an example of operation of a transmission system according to a second modification;

FIG. 10 is a block diagram illustrating an example of configuration of a transmission system according to a third modification;

FIG. 11 is a block diagram illustrating another example of the configuration of the transmission system according to the third modification;

FIG. 12 is a block diagram illustrating still another example of the configuration of the transmission system according to the third modification;

FIG. 13 is a flowchart illustrating an example of operation of the transmission system according to the third modification;

FIG. 14 is a block diagram illustrating an example of configuration of a transmission system according to a fourth modification;

FIG. 15 is a block diagram illustrating another example of the configuration of the transmission system according to the fourth modification;

FIG. 16 is a block diagram illustrating still another example of the configuration of the transmission system according to the fourth modification;

FIG. 17 is a block diagram illustrating still another example of the configuration of the transmission system according to the fourth modification;

FIG. 18 is a block diagram illustrating still another example of the configuration of the transmission system according to the fourth modification;

FIG. 19 is a block diagram illustrating still another example of the configuration of the transmission system according to the fourth modification;

FIG. 20 is a flowchart illustrating an example of operation of the transmission system according to the fourth modification;

FIG. 21 is a block diagram illustrating an example of configuration of a transmission system according to a fifth modification;

FIG. 22 is a flowchart illustrating an example of operation of the transmission system according to the fifth modification;

FIG. 23 is a flowchart illustrating an example of operation of a transmission system according to a sixth modification; and

FIG. 24 is a flowchart illustrating an example of operation of a transmission system according to a seventh modification.

### DESCRIPTION OF EMBODIMENT(S)

Hereinafter, exemplary embodiments will be described with reference to accompanying drawings. The following exemplary embodiments are merely examples and do not intend to exclude various modifications and variations to the proposed method and/or apparatus that are not specifically described herein. Rather, various modifications or variations may be made to the embodiments (for example, by combining the exemplary embodiments) without departing from the scope and spirit of the proposed method and/or apparatus.

### [1] Embodiment

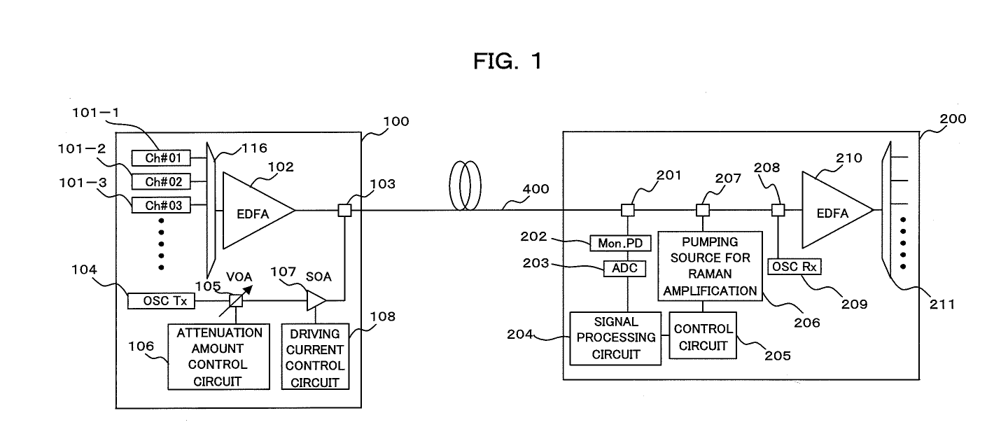

FIG. 1 is a block diagram illustrating an example of configuration of a WDM transmission system according to an embodiment. A WDM transmission system illustrated in FIG. 1 comprises, for example, an optical transmission apparatus 100 acting as an optical transmitting station, an optical transmission apparatus 200 acting as an optical receiving station, and an optical fiber 400 as being an example of an optical transmission line connecting the optical transmitting station 100 (optical transmission apparatus) to the optical receiving station 200 (optical reception apparatus). FIG. 1 illustrates a configuration, given attention to an optical communication in one way from the optical transmitting station 100 to the optical receiving station 200. However, the optical receiving station 200 can have the same configuration as the optical transmitting station 100 or vice versa to perform a two-way communication.

The optical transmitting station 100 illustrated in FIG. 1 has an optical amplifier 102 such as an EDFA or the like amplifying main signal light (WDM light). Similarly, the optical receiving station 200 has an optical amplifier 210 such as an EDFA or the like amplifying the main signal light (WDM light). Further, the optical transmission line 400 may be equipped with an EDFA to repeat and amplify the WDM light.

The optical receiving station 200 may have a pumping source for Raman amplification (hereinafter, referred to as a Raman pumping source) 206. Namely, the optical receiving station 200 can amplify the main signal light transmitted toward the optical receiving station 200 through the optical transmission line 400 by the use of stimulated Raman scattering phenomenon, by inserting the Raman pumping light generated by the Raman pumping source 206 toward the opposite optical transmitting station 200.

At the time of start of the operation of the WDM transmission system, the optical amplifiers 102 and 210, the Raman pumping source 206 and the like are started, for example.

On such occasion, if a portion in which an optical connector is opened exists or a portion in which an optical fiber is cut exists, high-powered light can be unexpectedly radiated from such the portion.

In order to prevent such radiation of the light, an OSC signal at an output lower than that of the main signal light (WDM light) is transmitted through the optical transmission line 400 to confirm the connection state of the transmission section before the start of the optical amplifiers 102 and 210, and the Raman pumping source 206 in some WDM transmission system.

However, if the distance of a transmission section between the optical transmitting station 100 and the optical receiving station 200 is long, there is a possibility that the received light level of the OSC signal transmitted from the optical transmitting station 100 does not satisfy the lower limit value at the optical receiving station 200.

In such case, confirmation of the connection state of the transmission section by the use of the OSC signal is not possible, hence the starting process on the optical amplifiers 102 and 210, and the Raman pumping source 206 is not possible either.

To cope with this problem, an optical amplifier for the OSC signal can be separately provided in the optical transmitting station 100 to amplify the OSC signal, thereby to secure a sufficient received light level at the optical receiving station 200.

However, there is a case where the required received light level at the optical receiving station 200 cannot be satisfied even if the OSC signal is amplified because of limitation of the amplifying performance (gain) of the optical amplifier.

As another solution to this problem, light at a wavelength differing from the wavelength of the OSC signal and at a bit rate lower than the bit rate of the OSC signal is used as light at a wavelength for connection confirmation (Pilot Channel (PC)) to confirm the connection, by giving attention to a characteristic that light at a lower bit rate can travel a longer transmission distance, in general.

Moreover, this method has a disadvantage that the system is required to have transceivers (supervisory control system) for OSC and PC separately, which causes complication of the hardware configuration of the optical transmission apparatus. Further, this method requires switching of the supervisory control system between OSC and PC according to the distance of a transmission section, or system starting sequence using two channels, OSC and PC, which causes complication of the apparatus control.

To overcome the above disadvantages, the optical transmitting station 100 according to this example changes the power level of the transmission light of the OSC signal, which is an example of the control signal, at a bit rate (frequency) lower than the bit rate (frequency) of the OSC signal (modulates the intensity thereof), and transmits the signal to the optical receiving station 200.

The changed (modulated) signal light can be used as control signal light for apparatus starting (for starting the Raman pumping light, for example). As an example of the ways for changing the transmission light power level of the OSC signal, there are a method in which the gain (driving current) of the semiconductor optical amplifier (SOA) amplifying the OSC signal is changed, a method in which the input or output optical level of the SOA is changed with the gain (driving current) of the SOA being constant, etc. Details of these methods will be described later. This corresponds to that apparatus (Raman pumping light) start information, which is an example of control information, is superposed on the OSC signal which is used for connection confirmation.

Even if the optical receiving station 200 cannot receive and identify the OSC signal at a high bit rate, the optical receiving station 200 can start the apparatus starting process, that is, can start the Raman pumping source 206, for example, by detecting (identifying) frequency components of the apparatus starting signal at a low bit rate.

In other words, the probability that the optical receiving station 200 can receive and identify the apparatus starting signal at a bit rate lower than the bit rate of the OSC signal is increased even when the transmission section is too long for the OSC signal at the original bit rate to practically reach the optical receiving station 200 and to be identified by the same.

Accordingly, it is possible to practically extend the transmission distance of the apparatus starting signal, which is an example of the control signal, without preparing a channel for connection confirmation apart from OSC. As a result, it is possible to improve the rate of success of the control (for example, to start the Raman pumping source 206) that helps the OSC signal reach the optical receiving station 200, thereby securely carrying out the system starting control in the WDM transmission system.

In addition, there is no need to prepare a separate channel for connection confirmation apart from the OSC signal, which is helpful to avoid the configuration of and control on the optical transmission apparatuses 100 and 200 from being complicated more than necessary.

In a direction from the optical receiving station 200 to the optical transmitting station 100, the above connection confirmation and start control can be carried out by transmitting the apparatus starting signal in a way similar to the above.

### [2] Practical Example of WDM Transmission System

Hereinafter, detailed description will be made of the above-described WDM transmission system.

(2.1) Optical Transmitting Station 100

The optical transmitting station 100 illustrated in FIG. 1 has, for example, a plurality of signal light transmitters 101-1, 101-2, 101-3, . . . , and 101-n (n is an integer not less than two), a WDM coupler 116, an optical amplifier 102, and an optical coupler 103 other than the above-mentioned optical amplifier 102. These elements are used as an example of the main signal light transmission system. The optical transmitting station 100 also has an OSC optical transmitting system OSC signal transmitter (OSC Tx) 104, a variable optical attenuator (VOA) 105, an attenuation amount control circuit 106, an SOA 107, and a driving current control circuit 108. Incidentally, when the signal light transmitters 101-1, 101-2, 101-3, . . . , and 101-n are not discriminated from one another, the signal light transmitter will be simply referred to as a signal optical transmitter 101. Further, the number of the signal light transmitters 101 is not limited to the number illustrated in FIG. 1.

Each of the signal light transmitters 101 generates main signal light at any one of wavelengths (channel) to be wavelength-multiplexed as WDM light, and sends out the light, which includes a light source such as a laser diode (LD) or the like, an optical modulator for superposing data onto light from the light source, etc.

The WDM coupler 116 wavelength-multiplexes the main signal light at a plurality of wavelengths from the signal light transmitters 101 onto the WDM light.

The optical amplifier 102 amplifies the WDM light (main signal light) from the WDM coupler 116. It is preferable that the optical amplifier 102 be started after the connection confirmation is done with the OSC signal, as stated hereinbefore.

The OSC signal transmitter (transmitter) 104 generates the OSC signal, and transmits the OSC signal to the optical transmission line 400. The OSC signal in this example has a first bit rate (frequency f_{osc}). The OSC signal is used as an example of the control signal for the use of connection confirmation between the optical transmitting station 100 and the optical receiving station 200.

The VOA (optical attenuator) 105 has a function of attenuating the optical power level of the OSC signal from the OSC signal transmitter 104. The attenuation amount by the VOA 105 can be controlled by the attenuation amount control circuit 106, for example.

The attenuation amount control circuit 106 controls the attenuation amount by the VOA 105. The attenuation amount control circuit 106 controls the attenuation amount by the VOA 105 so that the optical power (level) of the OSC signal generated by the OSC signal transmitter 104 falls within an allowable range of the input optical level of the SOA 107 in the following stage. Alternatively, the attenuation control circuit 106 may control the attenuation amount by the VOA 105 so that the input optical power level to the SOA 107 is constant.

The SOA (optical amplifier) 107 is an optical device which has both a function as an optical gate switch and an optical amplifying function. The SOA 107 in this example amplifies the OSC signal whose optical power level has been adjusted by the VOA 105, with an optical gain according to the driving current supplied from the driving current control circuit 108.

The driving current control circuit (gain controller) 108 controls the driving current to be given to the SOA 107 to control the optical gain of the SOA 107. When the bit rate (frequency) of the driving current is changed with the input optical power level of the SOA 107 being constant, the optical gain of the SOA 107 is changed according to the change of the bit rate. When driving current to be given to the SOA 107 is changed at a second bit rate (frequency f_{pc}) lower than the first bit rate (frequency f_{osc}) of the OSC signal, the optical gain of the SOA 107 is changed at the frequency f_{pc}, hence the OSC signal on which components of the frequency f_{pc} have been superposed is outputted from the SOA 107. In this example, a signal having components of the frequency f_{pc} is used as the control signal for starting the optical receiving station 200.

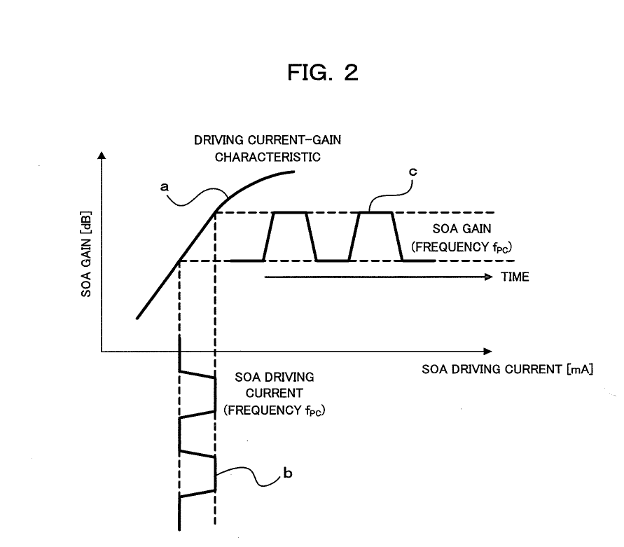

FIG. 2 illustrates an example of the above. As illustrated in FIG. 2, the SOA 107 is assumed to have a driving current-gain characteristic denoted by a reference character “a”, for example. Namely, the optical gain (SOA gain) of the SOA 107 is (linearly) increased in proportion to the magnitude of the driving current [mA] given from the driving current control circuit 108. Meanwhile, when the driving current becomes larger than a certain value, the optical gain is saturated, not proportionally increased. For this, the operation point of the SOA 107 is set in a linear region of the above characteristic.

When the driving current at the second bit rate (frequency f_{pc}) lower than the first bit rate (frequency f_{osc}) of the OSC signal as denoted by a reference character “b” in FIG. 2 is given to the SOA 107 from the driving current control circuit 108, the optical gain of the SOA 107 is changed at the frequency f_{pc} as denoted by a reference character “c” in FIG. 2.

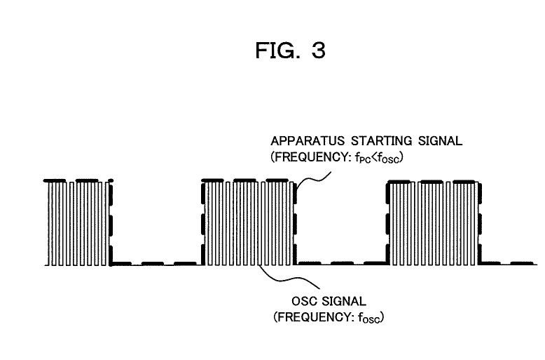

Accordingly, when the OSC signal at the frequency f_{osc} is inputted to the SOA 107, the optical gain is changed at the frequency f_{pc}, hence components at the frequency f_{pc} are superposed on the OSC signal, as illustrated in FIG. 3, for example. The optical transmitting station 100 in this example generates the control signal (apparatus starting signal) for starting the apparatus at the frequency f_{pc}, as above.

The VOA 105, the attenuation amount control circuit 106, the SOA 107 and the driving current control circuit 108 together function as an example of a controller which changes the power level of the OSC signal having the frequency f_{osc} with the frequency f_{pc} lower than the frequency f_{osc}.

The optical coupler 103 couples the WDM signal amplified by the optical amplifier 102 to outputted light of the SOA 107, that is, the OSC signal (apparatus starting signal), and outputs the coupled signal to the optical transmission line 400.

As stated above, the optical transmitting station 100 in this example inputs the OSC signal having the frequency f_{osc} to the SOA 107 to periodically change the optical gain of the SOA 107 at the frequency f_{pc} (<f_{osc}), thereby generating the OSC signal onto which the apparatus starting signal having the frequency f_{pc} has been superposed. The optical transmitting station 100 can transmit the OSC signal (apparatus starting signal) to the optical receiving station 200 through the optical transmission line 400.

In a long-distance transmission section between the optical transmitting station 100 and the optical receiving station 200 where the OSC signal cannot reach even when amplified, it is possible to improve the probability that the OSC signal (apparatus starting signal) can reach the optical receiving station 200. Since the apparatus starting signal is generated by modulating the OSC signal, there is no need to provide a separate transmitter (light source, optical modulator) such as a pilot channel. Accordingly, switching of the transceiver (supervisory control system), and switching of the starting sequence according to the transmission distance between the optical transmitting station 100 and the optical receiving station 200 are unnecessary, hence the apparatus control is not complicated.

(2.2) Optical Receiving Station 200

The optical receiving station 200 illustrated in FIG. 1 has an optical coupler 201, a monitor photo diode (Mon PD, PD for optical monitor) 202, and an analog digital converter (ADC, analog/digital converting circuit) 203, in addition to the optical amplifier 201 and the Raman pumping light source 206 described hereinbefore. Further, the optical receiving station 200 has a signal processing circuit 204, a control circuit 205, optical couplers 207 and 208, an OSC signal receiver (OSC Rx) 209 and a WDM coupler 211.

The optical coupler (receiver) 201 demultiplexes signal light having wavelength components of the OSC from the signal light received through the optical transmission line 400, and outputs the signal light to the PD for optical monitor 202.

The PD for optical monitor (light receiving device) 202 photo-electric-converts the optical components of the OSC signal inputted from the optical coupler 201 to generate an electric signal (analog signal) according to the received optical power. Since the bit rate (frequency f_{pc}) of the apparatus starting signal is lower than the bit rate of the OSC signal in order to extend the transmittable distance, there is a fear that the apparatus starting signal deviates off the signal bandwidth that the OSC signal receiver 209 can receive. For this, the PD 202, which is used to monitor the received optical power (level), is used to receive the apparatus starting signal in this example.

In the following stage of the PD for optical monitor 202, an active filter which allows components at the frequency f_{pc} of the electric signal to pass therethrough may be disposed. By doing so, it is possible to increase the probability that the signal components at the low bit rate (frequency f_{pc}) superposed on the OSC signal can be detected even when the received optical level of the received OSC signal is low.

The ADC (sampler) 203 samples the analog signal obtained by the PD for optical monitor 202 (or the above-mentioned active filter) in a predetermined cycle to convert the analog signal to a digital signal. This digital signal is used as a monitor value of the received optical power in the signal processing circuit 204.

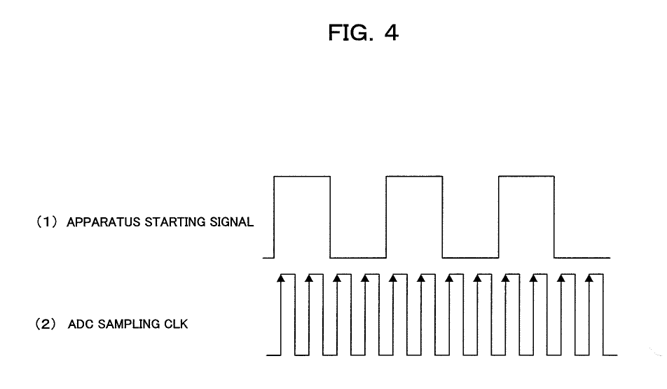

If the bit rate (frequency f_{pc}) of the apparatus staring signal is set to a lower frequency than the sampling cycle of the ADC 203, conversely speaking, if the detection cycle for the received optical level of the inputted light from the optical transmission line 400 is set to a higher frequency than the frequency f_{pc}, it becomes possible to appropriately sample the apparatus starting signal and identify the same. An example of this is illustrated in FIG. 4. As illustrated in FIG. 4, if the apparatus starting signal having a waveform (frequency f_{pc}) denoted by (1) is sampled at a clock for ADC sampling having a frequency higher than the frequency f_{pc} denoted by (2), the apparatus starting signal can be appropriately identified.

The signal processing circuit 204 monitors whether the apparatus starting signal transmitted from the optical transmitting station 100 is received on the basis of a result of identification by the ADC 203. For example, the signal processing circuit 204 determines that the apparatus starting signal has been received, on the basis of a fact that the components of the frequency f_{pc} have been observed in the output of the ADC 203.

The control circuit (Raman pumping source controller) 205 performs a starting control on the Raman pumping source 206 on the basis of a result of the determination made by the signal processing circuit 204. For example, when signal processing circuit 204 determines that the apparatus starting signal has been received, the control circuit 205 performs the starting process on the Raman pumping source 206 on the assumption that the connection in the transmission section between the optical transmitting station 100 and the optical receiving station 200 is confirmed.

Whereby, the OSC signal is Raman-amplified in the optical transmission line 400, which enables the OSC signal receiver 209 to receive and identify the OSC signal having the original bit rate. Accordingly, the control circuit 205 notifies the optical transmitting station 100 of start of the Raman pumping source 206 (that is, reception of the apparatus starting signal), thereby letting the optical transmitting station 100 recognize that the modulation (superposition of the apparatus starting signal) on the OSC signal becomes unnecessary.

In other words, the control circuit 205 in this case functions as an example of a notifier which notifies the optical transmitting station 100 that the apparatus starting signal has been received by the optical receiving station 200. This notification can be done with the use of an optical transmission line (the opposite line) not illustrated for transmission in the opposite direction toward the optical transmitting station 100 from the optical receiving station 200. The optical transmitting station 100 having received this notification stops the modulation on the OSC signal, and carries out the starting control on the optical amplifier (EDFA) 102 when the OSC communication is established.

Namely, the PD for optical monitor 202, the ADC 203, the signal processing circuit 204 and the control circuit 205 in this example together function as an example of a monitor which monitors whether the signal light components (the above-mentioned apparatus starting signal) at the frequency f_{pc} are received or not.

The signal processing circuit 204 and the control circuit 205 in this example together function as an example of a system start processor which carries out a system starting process (for example, a starting process on the Raman pumping source 206) in the WDM transmission system when the reception of the apparatus starting signal is confirmed as a result of the monitoring.

On the other hand, when reception of the apparatus starting signal is not confirmed by the signal processing circuit 204, the control circuit 205 does not carry out the starting control on the optical amplifier 210 and the Raman pumping source 206.

The Raman pumping source 206 generates Raman pumping light to amplify (Raman amplification) the WDM signal transmitted from the optical transmitting station 100 with the use of the stimulated Raman scattering phenomenon in the optical transmission line 400. The Raman pumping source 206 can be started by the control circuit 205 after reception of the OSC signal or the apparatus starting signal is confirmed.

The optical coupler 207 inserts the Raman pumping light fed from the Raman pumping source 206 to the optical transmission line 400. The Raman pumping light is transmitted in a direction opposite to the transmission direction of the WDM signal transmitted through the optical transmission line 400.

The optical coupler 208 demultiplexes the OSC signal components of the WDM signal received through the optical transmission line 400, and outputs the components to the OSC signal receiver 208. Incidentally, the main signal light other than the OSC signal is outputted toward the optical amplifier 210.

The OSC signal receiver 209 performs a receiving process on the OSC signal demultiplexed by the optical coupler 208, and carries out various controls according to contents of the signal. In this example, when the OSC signal receiver 209 can identify reception of the OSC signal at a higher bit rate than that of the apparatus starting signal, the ADC 203 and the signal processing circuit 204 can identify the apparatus starting signal at a lower bit rate, as a matter of course.

The optical amplifier 210 amplifies the WDM signal received through the optical transmission line 400. The optical amplifier 210 is started under control after the OSC signal is received and identified by the OSC signal receiver 209 (that is, after the OSC communication is established), for example. The start of the optical amplifier 210 can be done by the control circuit 205, for example.

The WDM coupler 211 demultiplexes the WDM signal amplified by the optical amplifier 210 into signal light in each channel.

(2.3) Example of Operation of WDM Transmission System

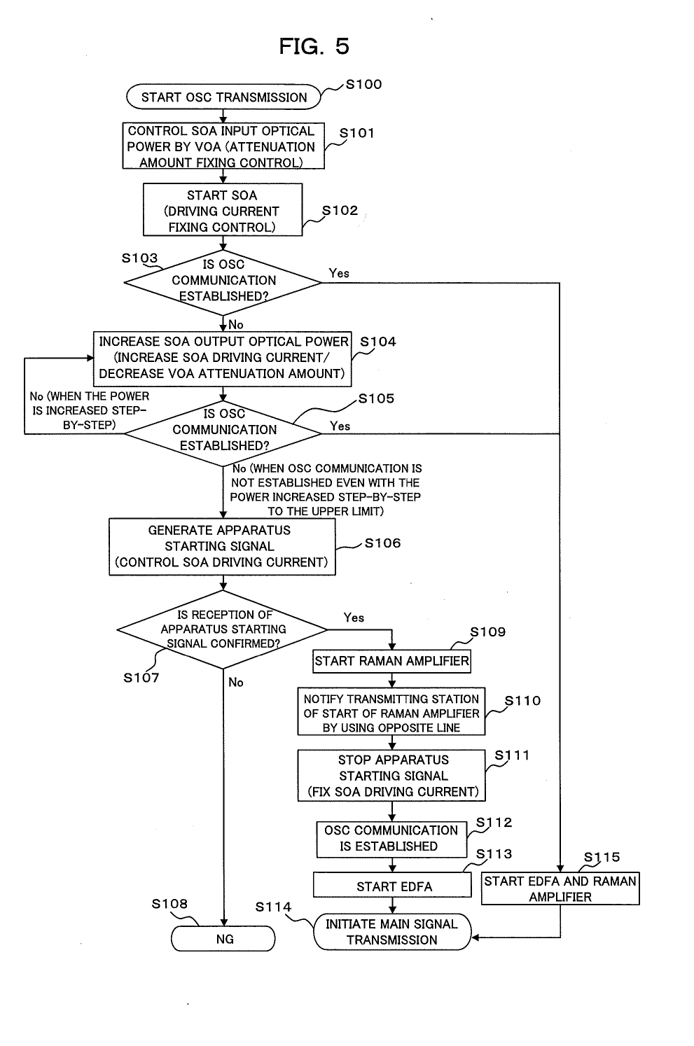

Next, an example of operation (starting method) of the above WDM transmission system will be described with reference to FIG. 5.

In the optical transmitting station 100, the OSC signal transmitter 104 starts generation and transmission of the OSC signal at the frequency f_{osc}, (step S100).

The VOA 105 and the attenuation amount control circuit 106 attenuate the OSC signal under control so that the optical power (level) of the OSC signal falls within an allowable range of the input optical level of the SOA 107 and the input optical power level to the SOA 107 is constant (step S101).

The driving current control circuit 108 controls the driving current to be given to the SOA 107 to a constant level (step S102), thereby controlling the amplification gain at the SOA 107 is a constant value.

The SOA 107 acts as a loss medium when not given the driving current at a predetermined level or more. For this, the driving current control circuit 108 gives the driving current to the SOA 107 so that the output optical power level from the SOA 107 is almost the same degree as the output optical power level from the OSC signal transmitter 104, for example.

The OSC signal amplified by the SOA 107 is inserted to the optical transmission line 400 by the optical coupler 103, and transmitted to the optical receiving station 200. The optical receiving station 200 determines whether the OSC signal is received and identified by the OSC signal receiver 209 (that is, whether the OSC communication is established) (step S103).

When the optical receiving station 200 determines that the OSC communication has been established as a result (Yes route at step S103), the optical receiving station 200 starts the Raman pumping source 206 and the optical amplifier (EDFA) 210 (step S115).

When the OSC communication in the opposite line is established, the optical transmitting station 100 starts the optical amplifier (EDFA) 102 to initiate transmission of the main signal light (WDM light) (step S114).

On the other hand, when the OSC communication is not established (No route at step S103), the optical transmitting station 100 carries out a control to increase the output optical power level of the OSC signal to be outputted from the SOA 107 (step S104). This control can be done by increasing the driving current to be given from the driving current control circuit 108 to the SOA 107, or decreasing the attenuation amount at the VOA 105 by the attenuation amount control circuit 106, or both. On such occasion, the output optical power level of the SOA 107 may be increased to a predetermined value (for example, upper limit value) at a time, or increased step-by-step to the upper limit value (No route (in the left direction on the paper) at step S105).

The optical transmitting station 100 determines whether the OSC communication with the optical receiving station 200 is established or not with the aid of an increase in the output optical power of the SOA 107 (step S105).

When the OSC communication is established (Yes route at step S105), the optical receiving station 200 starts the Raman pumping source 206 and the optical amplifier (EDFA) 210 (step S115). When the OSC communication in the opposite line is established, the optical transmitting station 100 starts the optical amplifier (EDFA) 102 to initiate transmission of the main signal light (WDM light) (step S114).

On the other hand, when the OSC communication fails to be established even though the output optical level of the SOA 107 has reached the upper limit value (No route (in the downward direction on the paper) at step S105), the optical transmitting station 100 controls the driving current to be given to the SOA 107 by means of the driving current control circuit 108 as described hereinbefore with reference to FIG. 2 to change the amplification gain at the SOA 107 at a frequency f_{pc} lower than the frequency f_{osc}, to change the optical power level of the OSC signal at the frequency f_{pc}, thereby to generate the apparatus starting signal having the frequency f_{pc} (step S106).

The OSC signal on which the apparatus starting signal has been superposed is inserted to the optical transmission line 400 by the optical coupler 103, and transmitted to the optical receiving station 200. In the optical receiving station 200, the PD for optical monitor 202, the ADC 203 and the signal processing circuit 204 together monitor whether the apparatus start signal is received and identified (step S107).

When the signal processing circuit 204 cannot identify reception of the apparatus starting signal (No route at step S107), the optical receiving station 200 does not perform the control to start the optical amplifier 210 and the Raman pumping source 206 (step S108).

On the other hand, when the signal processing circuit 204 identifies reception of the apparatus starting signal (Yes route at step S107), the optical receiving station 200 starts the Raman pumping source 206 by means of the control circuit 205 (step S109). The optical receiving station 200 notifies the optical transmitting station 100 of this start through the opposite line (step S110). The notification of the start of the Raman pumping source 206 also means a notification to the optical transmitting station 100 that the optical receiving station 200 (signal processing circuit 204) has confirmed reception of the apparatus starting signal.

In the optical transmitting station 100 having received the notification from the optical receiving station 200, the driving current control circuit 108 controls the driving current to be given to the SOA 107 to be constant to make the amplification gain at the SOA 107 constant, thereby to stop superposing the apparatus starting signal on the OSC signal (that is, stop generating the apparatus starting signal) (step S111).

Thereafter, in the optical receiving station 200, start of the Raman pumping source 206 allows the OSC signal receiver 209 to receive and identify the OSC signal from the optical transmitting station 100, hence the OSC communication with the optical transmitting station 100 is established (step S112). When the OSC communication is established, the optical receiving station 200 starts the optical amplifier (EDFA) 210.

When the OSC communication in the opposite line is established, the optical transmitting station 100 starts the EDFA 102 after confirming establishment of the OSC communication in the opposite line (step S113), and initiates transmission of the main signal line (WDM light) (step S114).

As stated above, in the WDM transmission system in this example, the optical transmitting station 100 inputs the OSC signal at the frequency f_{osc} to the SOA 107, periodically changes the optical gain of the SOA 107 at the frequency f_{pc} (<f_{osc}), thereby generating the OSC signal on which the apparatus starting signal at the frequency f_{pc} has been superposed. The optical transmitting station 100 transmits the OSC signal (apparatus starting signal) to the optical receiving station 200 through the optical transmission line 400.

Therefore even if the transmission section between the optical transmitting station 100 and the optical receiving station 200 is such a long distance that the OSC communication cannot be established without starting the Raman pumping source 206 in the optical receiving station 200 (that is, without Raman gain), it is possible to allow the apparatus starting signal to reach the optical receiving station 200. Whereby, the Raman pumping source 206 in the optical receiving station 200 can be started so that the rate of success of establishment of the OSC communication and start of the EDFAs 102 and 210 is improved.

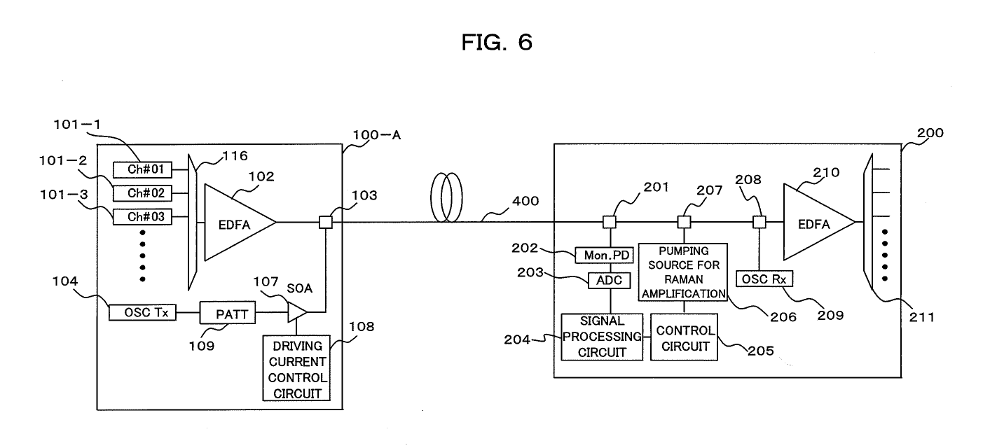

Meanwhile, an optical transmitting station 100-A illustrated in FIG. 6 may be alternatively used, instead of the optical transmitting station 100 illustrated in FIG. 1.

The optical transmitting station 100-A illustrated in FIG. 6 has a fixed attenuator (PATT) 109, instead of the VOA 105 and the attenuation amount control circuit 106 in the optical transmitting station 100. Incidentally, the remaining configuration of the optical transmitting station 100-A is similar to that of the optical transmitting station 100, and configurations of the optical transmitting line 400 and optical receiving station 200 are the same as those illustrated in FIG. 1.

The PATT 109 has a function of attenuating the optical power level of the OSC signal from the OSC signal transmitter 104. The PATT 109 in this example controls the attenuation amount for the OSC signal so that the optical power (level) of the OSC signal generated by the OSC signal transmitter 104 falls within an allowable level of the input optical level of the SOA 107 in the following stage. Alternatively, the PATT 109 may control the attenuation amount so that the input optical power level to the SOA 107 is constant.

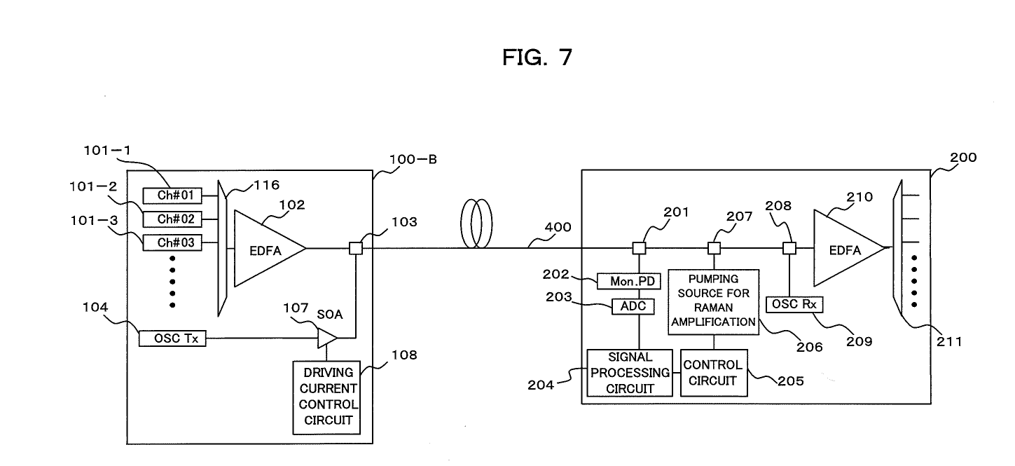

Instead of the optical transmitting station 100 illustrated in FIG. 1 or the optical transmitting station 100-A illustrated in FIG. 6, an optical transmitting station 100-B illustrated in FIG. 7 may be used.

The optical transmitting station 100-B illustrated in FIG. 7 has a configuration obtained by removing the VOA 105 and the attenuation amount control circuit 106 from the optical transmitting station 100. The remaining configuration of the optical transmitting station 100-B is similar to that of the optical transmitting station 100, and the configurations of the optical transmission line 400 and the optical receiving station 200 are the same as those illustrated in FIG. 1.

In the optical transmitting station 100-B, the OSC signal transmitter 104 beforehand controls the power level of the OSC signal so that the optical power (level) of the OSC signal falls within an allowable range of the input optical level of the SOA 107 in the following stage. Alternatively, the OSC signal transmitter 104 in the optical transmitting station 100-B may beforehand control the power level of the OSC signal so that the input optical power level to the SOA 107 is constant.

Each of the optical transmitting station 100-A and the optical transmitting station 100-B in the WDM transmission systems illustrated in FIGS. 6 and 7 operates as does in the above-described example illustrated in FIG. 5 to provide the same working effects as the above-described WDM transmission system illustrated in FIG. 1.

(2.4) First Modification

In the above examples, the amplification gain of the SOA 107 is changed at the frequency f_{pc} with the input optical power level to the SOA 107 being constant to generate the apparatus starting signal. Alternatively, the attenuation amount at the VOA 105 may be changed at the frequency f_{pc} with the amplification gain of the SOA 107 being constant to generate the apparatus starting signal.

The attenuation amount control circuit (attenuation amount controller) 106 in this example changes the driving current of the VOA 105 at the second bit rate (frequency f_{pc}) lower than the first bit rate (frequency f_{osc}) of the OSC signal to change the attenuation amount at the VOA 105 at the frequency f_{pc}. Whereby, the VOA 105 outputs signal light on which control information used to start the optical receiving station 200 has been superposed as components of the frequency f_{pc}.

Since the SOA 107 having been inputted the apparatus starting signal from the VOA 105 is given a constant driving current from the driving current control circuit 108, the SOA 107 generates a constant amplification gain.

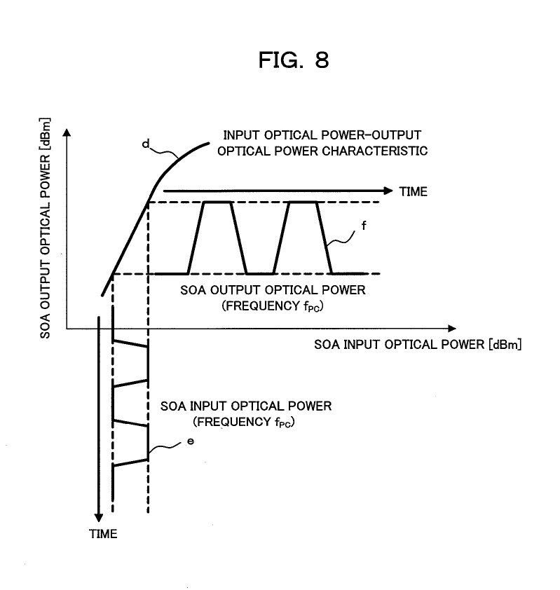

An example of this is illustrated in FIG. 8. As illustrated in FIG. 8, the SOA 107 is assumed to have an input optical power/output optical power characteristic denoted by a reference character “d”, and be given a constant driving current, for example. Namely, the output optical power [dBm] of the SOA 107 is increased (linearly) in proportional to the magnitude of the input optical power [dBm] given to the SOA 107 from the VOA 105 in the preceding stage. When the input optical power reaches a certain constant value or more, the output optical power is saturated, not increased proportionally. For this, the operation point of the SOA 107 is set in a linear region of the above characteristic.

When the OSC signal on which the apparatus starting signal at the second bit rate (frequency f_{pc}) denoted by a reference character “e” in FIG. 8 lower than the first bit rate (frequency f_{osc}) of the OSC signal has been superposed is given to the SOA 107, the output optical power of the SOA 107 is amplified with the frequency f_{pc} being kept as denoted by a reference character “f” in FIG. 8 because the optical gain of the SOA 107 is constant.

In this example, components of the frequency f_{pc} are superposed on the OSC signal as illustrated in FIG. 3, for example. The optical transmitting station 100 in this example generates the control signal for apparatus starting at the frequency f_{pc} as above.

Accordingly, the WDM transmission system in this example can provide the same working effects as the above embodiment.

(2.5) Second Modification

In the above examples, the amplification gain of the SOA 107 or the attenuation amount of the VOA 105 is changed at the frequency f_{pc} to generate the apparatus starting signal. Alternatively, the amplification gain of the SOA 107 and the attenuation amount of the VOA 105 may be controlled to be constant, and outputting and stopping of the OSC signal transmitter 104 may be switched at the frequency f_{pc} to generate the apparatus starting signal.

In concrete, the optical transmitting station 100 according to this example periodically switches, at the frequency f_{pc}, the outputting/stopping (on/off) operation of the OSC signal transmitter 104 by a controlling function that the OSC signal transmitter 104 is beforehand provided or by a control from the outside, for example, to generate the apparatus starting signal at the frequency f_{pc}. Likewise, the similar on/off control may be performed in the optical transmitting stations 100-A and 100-B illustrated in FIGS. 6 and 7.

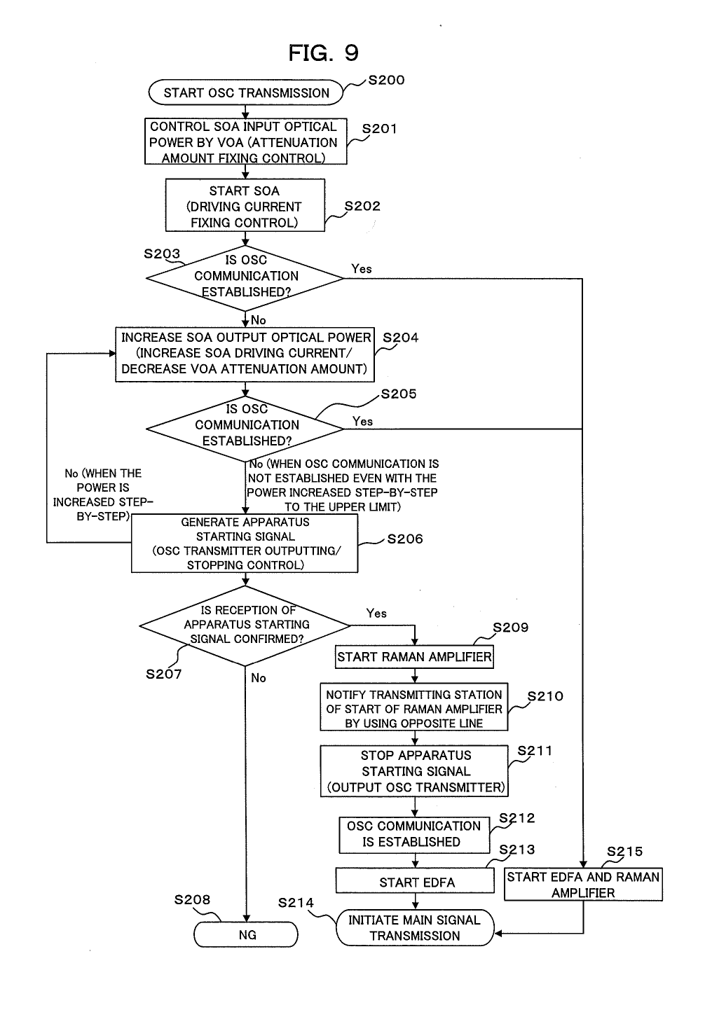

Next, an example of the operation of the WDM transmission system of this example will be described with reference to FIG. 9.

In the optical transmitting station 100, the OSC signal transmitter 104 starts generation and transmission of the OSC signal at the frequency f_{OSC} (step S200).

The OSC signal is attenuated under control of the VOA 105 and the attenuation amount control circuit 106 so that the optical power (level) of the OSC signal falls within an allowable range of the input optical level of the SOA 107 and the input optical power level to the SOA 107 is constant (step S201).

The driving current control circuit 108 controls the driving current to be given to the SOA 107 at a constant level (step S202), and controls the same so that the amplification gain at the SOA 107 is a constant value.

When not given a driving current at a predetermined level or more, the SOA 107 acts as a loss medium. For this, the driving current control circuit 108 gives the driving current to the SOA 107 so that the output optical power level from the SOA 107 is at almost the same level as the output optical power level from the OSC signal transmitter 104.

The OSC signal amplified by the SOA 107 is inserted to the optical transmission line 400 by the optical coupler 103, and transmitted to the optical receiving station 200. The optical receiving station 200 determines whether the OSC signal receiver 209 receives and identifies the OSC signal (that is, whether the OSC communication is established) (step S203).

When determining that the OSC communication has been established as a result (Yes route at step S203), the optical receiving station 200 starts the Raman pumping source 206 and the optical amplifier (EDFA) 210 (step S215).

The optical transmitting station 100 starts the optical amplifier (EDFA) 102 because of establishment of the OSC communication in the opposite line to initiate transmission of the main signal light (WDM light) (step S214).

On the other hand, when the OSC communication is not established (No route at step S203), the optical transmitting station 100 increases the output optical power level of the OSC signal outputted from the SOA 107 under control (step S204). This control can be done by increasing the driving current given to the SOA 107 from the driving current control circuit 108, or decreasing the attenuation amount at the VOA 105 by the attenuation amount control circuit 106, or both. On such occasion, the output optical power level of the SOA 107 may be increased at a time to a predetermined value (the upper limit value, for example), or increased step-by-step to the upper limit value (No route (in the leftward direction on the paper) at step S205).

The optical transmitting station 100 determines whether the OSC communication with the optical receiving station 200 is established with the help of an increase in the output optical power level of the SOA 107 (step S205).

When the OSC communication is established (Yes route at step S205), the optical receiving station 200 starts the Raman pumping source 206 and the optical amplifier (EDFA) 210 (step S215). When the OSC communication in the opposite line is established, the optical transmitting station 100 starts the optical amplifier (EDFA) 102 to initiate transmission of the main signal light (WDM light) (step S214).

On the other hand, when the OSC communication is not established even though the output optical power level of the SOA 107 has reached the upper limit value (No route (in the downward direction on the paper) at step S205), the optical transmitting station 100 switches the OSC signal transmitter 104 between the outputting operation and the stopping operation thereof at the frequency f_{pc} lower than the frequency f_{osc} to change the power level of the OSC signal at the frequency f_{pc}, thereby generating the apparatus starting signal at the frequency f_{pc} (step S206).

The OSC signal on which the apparatus starting signal has been superposed is inserted to the optical transmission line 400 by the optical coupler 103, and transmitted to the optical receiving station 200. In the optical receiving station 200, the PD for optical monitor 202, the ADC 203 and the signal processing circuit 204 together monitor whether the apparatus starting signal is received and identified (step S207).

When the signal processing circuit 204 does not identify reception of the apparatus starting signal (No route at step S207), the optical receiving station 200 does not perform the control to start the optical amplifier 210 and the Raman pumping source 206 (step S208).

On the other hand, when the signal processing circuit 204 identifies reception of the apparatus starting signal (Yes route at step S207), the optical receiving station 200 starts the Raman pumping source 206 by means of the control circuit 205 (step S209). The optical receiving station 200 notifies the optical transmitting station 100 of this start through the opposite line (step S210). The notification of start of the Raman pumping source 206 also notifies the optical transmitting station 100 that the optical receiving station 200 (signal processing circuit 204) has confirmed the reception of the apparatus starting signal.

In the optical transmitting station 100 having received the above notification from the optical receiving station 200, the OSC signal transmitter 104 performs a control to keep outputting the OSC signal, stopping superposing the apparatus starting signal onto the OSC signal (that is, stopping generation of the apparatus starting signal) (step S211).

Thereafter, start of the Raman pumping source 206 enables the OSC signal receiver 209 in the optical receiving station 200 to receive and identify the OSC signal from the optical transmitting station 100, whereby the OSC communication with the optical transmitting station 100 is established (step S212). When the OSC communication is established, the optical receiving station 200 starts the optical amplifier (EDFA) 210.

When the OSC communication in the opposite line is established, the optical transmitting station 100 starts the EDFA 102 after confirming the establishment of the OSC communication in the opposite line (step S213), and initiates transmission of the main signal light (WDM light) (step S214).

As above, this modification can provide the same working effects as the above-described embodiment.

(2.6) Third Modification

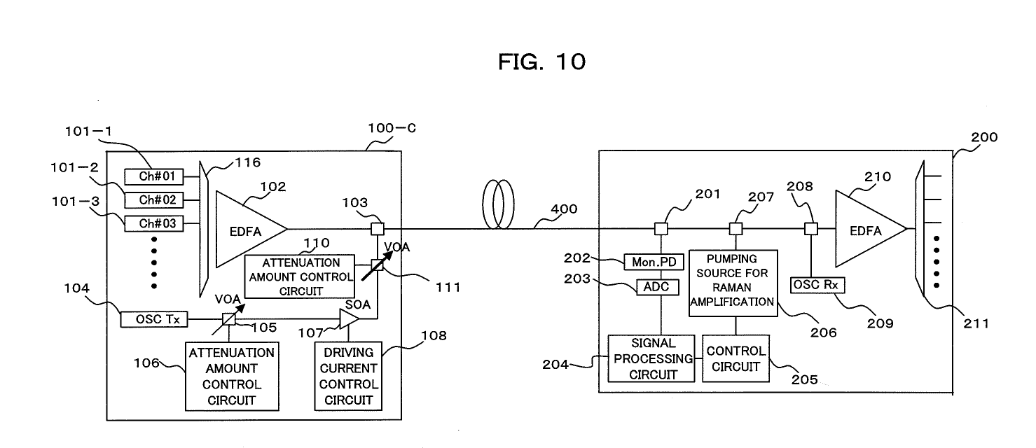

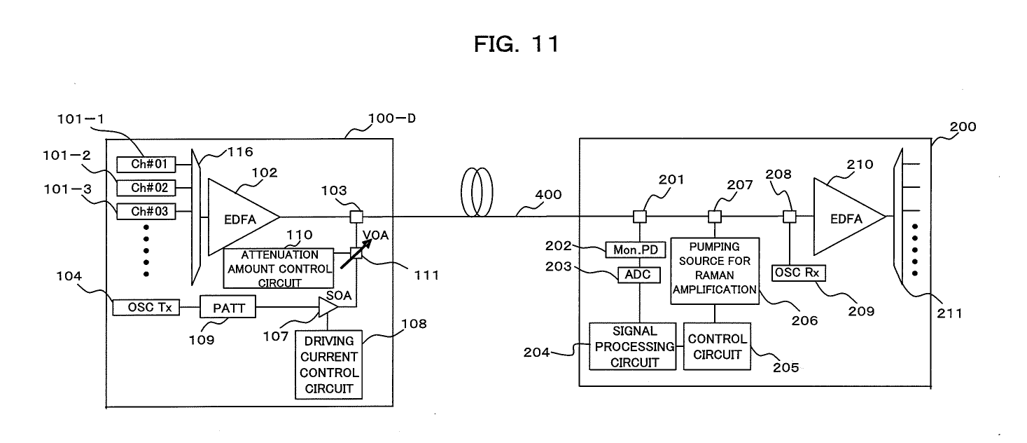

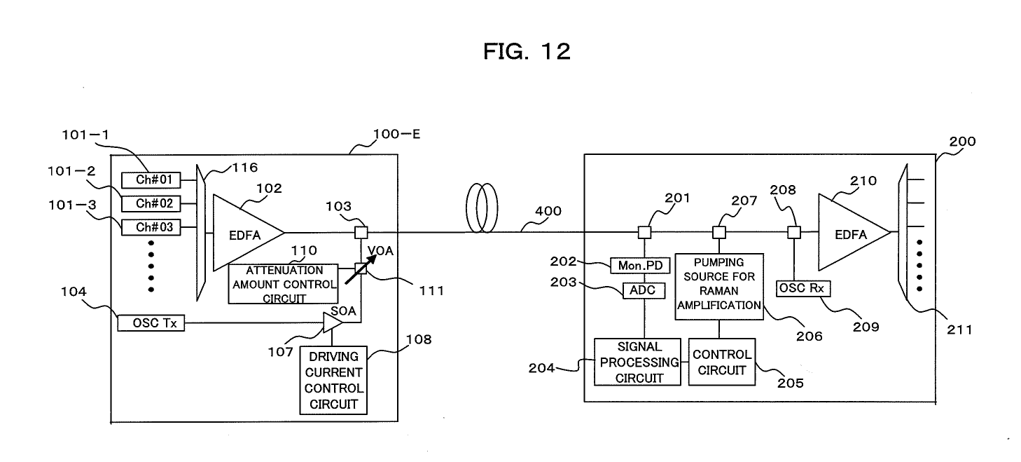

Instead of the optical transmitting stations 100, 100-A and 100-B illustrated in FIGS. 1, 6 and 7, optical transmitting stations 100-C, 100-D and 100-E illustrated in FIGS. 10 to 12 are employable. Each of the optical transmitting stations 100-C, 100-D and 100-E has a VOA 111 and an attenuation amount control circuit 110 between the SOA 107 and the optical coupler 103 in the configuration of the optical transmitting station 100, 100-A or 100-B. Incidentally, the remaining configuration of each of the optical transmitting stations 100-C, 100-D and 100-E is the same as those of the optical transmitting stations 100, 100-A and 100-B, and the configurations of the EDFAs 102, the optical transmission line 400 and the optical receiving station 200 are the same as those illustrated in FIG. 1.

The optical transmitting stations 100-C, 100-D and 100-E each controls the attenuation amount of the VOA 105 and the amplification gain of the SOA 107 to be constant, changes the attenuation amount at the VOA 111 at the frequency f_{pc}, thereby generating the apparatus starting signal.

The VOA (optical attenuator) 111 has a function of attenuating the optical power level of the OSC signal from the SOA 107. The attenuation by the VOA 111 can be controlled by the attenuation amount control circuit 110, for example.

The attenuation amount control circuit 110 controls the attenuation amount at the VOA 111. The attenuation amount control circuit (attenuation amount controller) 110 in this example changes the driving current of the VOA 111 at the second bit rate (frequency f_{pc}) lower than the first bit rate (frequency f_{osc}) of the OSC signal to change the attenuation amount at the VOA 111 at the frequency f_{pc}. Whereby, the OSC signal, on which control information used to start the optical receiving station 200 has been superposed as components of the frequency f_{pc}, is outputted from the VOA 111.

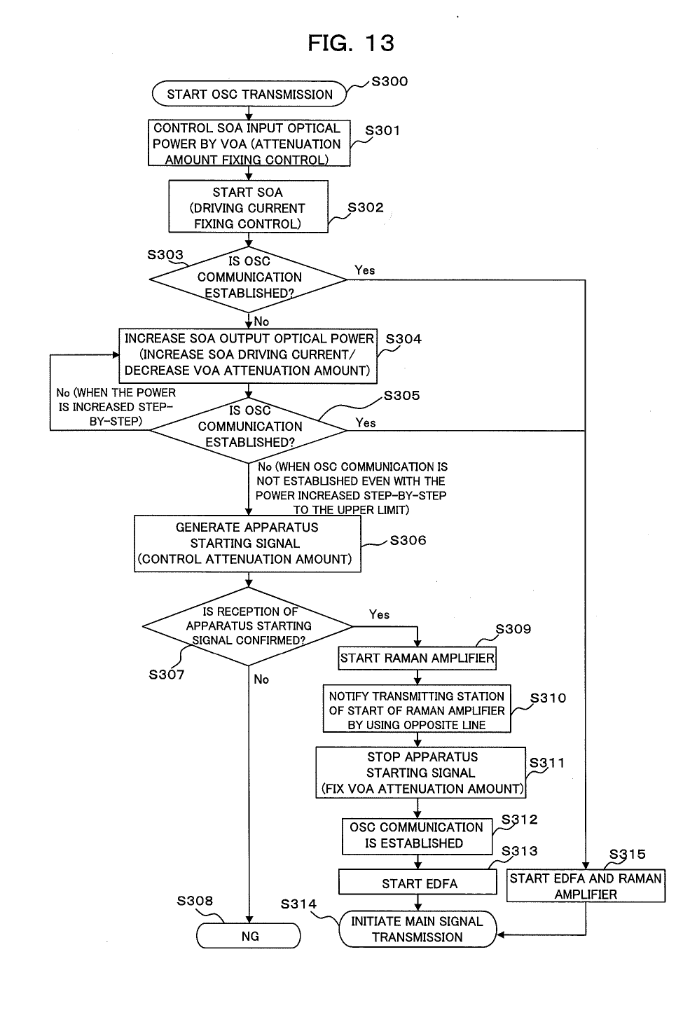

Next, an example of operation (starting method) of the above WDM transmission system will be described with reference to FIG. 13.

In the optical transmitting station 100-C, 100-D or 100-E, the OSC signal transmitter 104 starts generation and transmission of the OSC signal at the frequency f_{osc} (step S300).

The OSC signal is attenuated under control of the VOA 105 and the attenuation amount control circuit 106 so that the optical power (level) of the OSC signal falls within an allowable range of the input optical level of the SOA 107 and the input optical power level to the SOA 107 is constant (step S301).

The driving current control circuit 108 controls the driving current to be given to the SOA 107 to a constant level (step S302), and controls the amplification gain at the SOA 107 to a constant value.

The SOA 107 acts as a loss medium when not given the driving current at a predetermine level or more. For this, the driving current control circuit 108 gives the driving current to the SOA 107 so that the output optical power level from the SOA 107 is almost the same level as the output optical power level from the OSC signal transmitter 104.

The OSC signal amplified by the SOA 107 is inserted to the optical transmission line 400 by the optical coupler 103, and transmitted to the optical receiving station 200. The optical receiving station 200 determines whether the OSC signal receiver 209 receives and identifies the OSC signal (whether the OSC communication is established) (step S303).

When it is determined as a result that the OSC communication has been established (Yes route at step S303), the optical receiving station 200 starts the Raman pumping source 206 and the optical amplifier (EDFA) 210 (step S315).

When the OSC communication in the opposite line is established, the optical transmitting station 100-C, 100-D or 100-E starts the optical amplifier (EDFA) 102 to initiate transmission of the main signal light (WDM light) (step S314).

On the other hand, when the OSC communication is not yet established (No route at step S303), the optical transmitting station 100-C, 100-D or 100-E performs a control to increase the output optical power level of the OSC signal outputted from the SOA 107 (step S304). This control can be done by increasing the driving current to be given to the SOA 107 from the driving current control circuit 108, or decreasing the attenuation amount at the VOA 105 by the attenuation amount control circuit 106, or both. On such occasion, the output optical power level may be increased at a time to a predetermined value (for example, upper limit value), or may be increased step-by-step to the upper limit value (No route (in the leftward direction on the paper) at step S305).

The optical transmitting station 100-C, 100-D or 100-E determines whether the OSC communication with the optical receiving station is established with the help of an increase in the output optical power of the SOA 107 (step S305).

When the OSC communication is established (Yes route at step S305), the optical receiving station 200 starts the Raman pumping source 206 and the optical amplifier (EDFA) 210 (step S315). Because of establishment of the OSC communication in the opposite line, the optical transmitting station 100-C, 100-D or 100-E starts the optical amplifier (EDFA) 102 to initiate transmission of the main signal light (WDM light) (step S314).

On the other hand, when the OSC communication is not yet established even though the output optical power level has reached the upper limit value (No route (in the downward direction on the paper) at step S305), the optical transmitting station 100-C, 100-D or 100-E changes the attenuation amount of the VOA 111 at the frequency f_{pc} lower than the frequency f_{osc} to change the power level of the OSC signal at the frequency f_{pc}, thereby generating the apparatus starting signal (step S306).

The OSC signal on which the apparatus starting signal has been superposed is inserted to the optical transmission line 400 by the optical coupler 103, and transmitted to the optical receiving station 200. In the optical receiving station 200, the PD for optical monitor 202, the ADC 203 and the signal processing circuit 204 together monitor whether the apparatus starting signal is received and identified (step S307).

When the signal processing circuit 204 cannot identify reception of the apparatus starting signal (No route at step S307), the optical receiving station 200 does not perform a control to start the optical amplifier 210 and the Raman pumping source 206 (step S308).

On the other hand, when the signal processing circuit 204 identifies reception of the apparatus starting signal (Yes route at step S307), the optical receiving station 200 starts the Raman pumping source 206 by means of the control circuit 205 (step S309). The optical receiving station 200 notifies the optical transmitting station 100-C, 100-D or 100-E of this start with the use of the opposite line (step S310). This notification of start of the Raman pumping source 206 also has a meaning that the reception of the apparatus starting signal has been identified by the optical receiving station (signal processing circuit 204).

The optical transmitting station 100-C, 100-D or 100-E having received the notification from the optical receiving station 200 controls the attenuation amount at the VOA 105 to a constant value to stop superposing the apparatus starting signal onto the OSC signal (that is, to stop generation of the apparatus starting signal) (step S311).

Thereafter, with the help of the start of the Raman pumping source 206, the optical receiving station 200 comes to be able to receive and identify the OSC signal from the optical transmitting station 100-C, 100-D or 100-E by means of the OSC signal receiver 209, hence the OSC communication with the optical transmitting station 100-C, 100-D or 100-E is established (step S312). When the OSC communication is established, the optical receiving station 200 starts the optical amplifier (EDFA) 210.

When the OSC communication in the opposite line is established, the optical transmitting station 100-C, 100-D or 100-E starts the EDFA 102 after confirming the establishment of the OSC communication (step S313), and initiates transmission of the main signal light (WDM light) (step S314).

This modification can provide the same working effects as the above-described embodiments.

(2.7) Fourth Modification

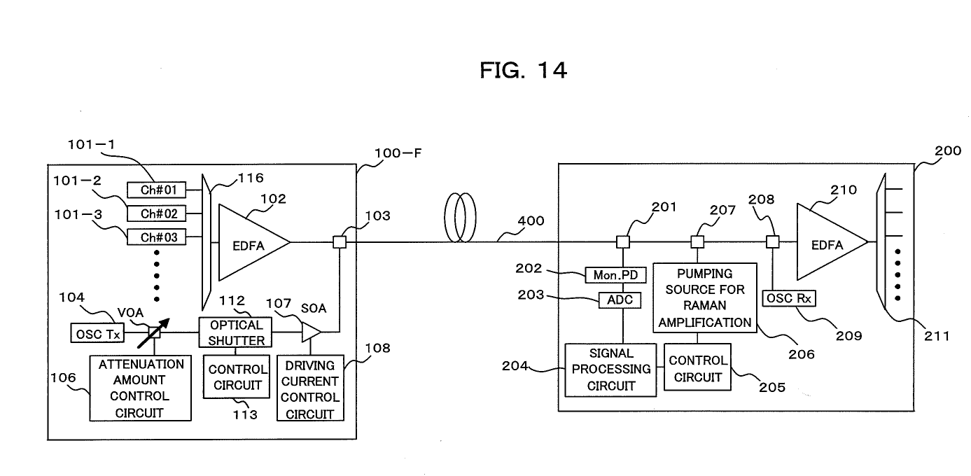

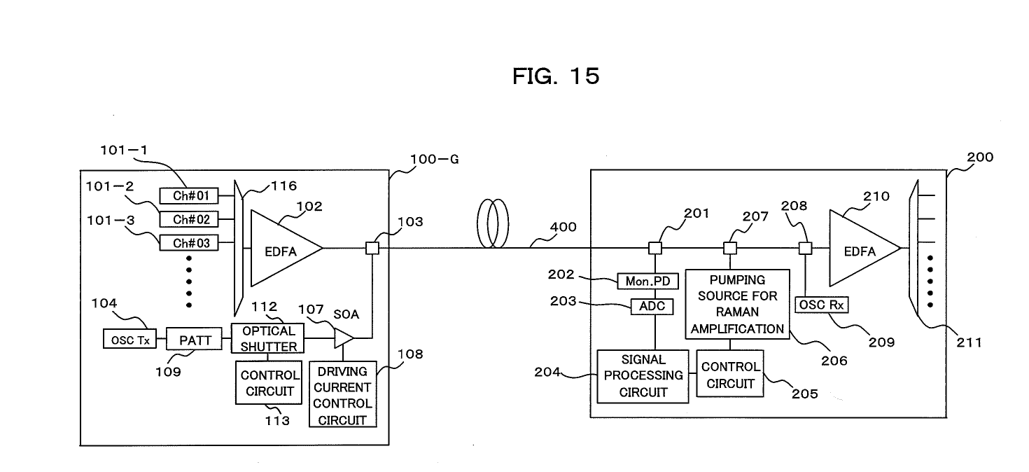

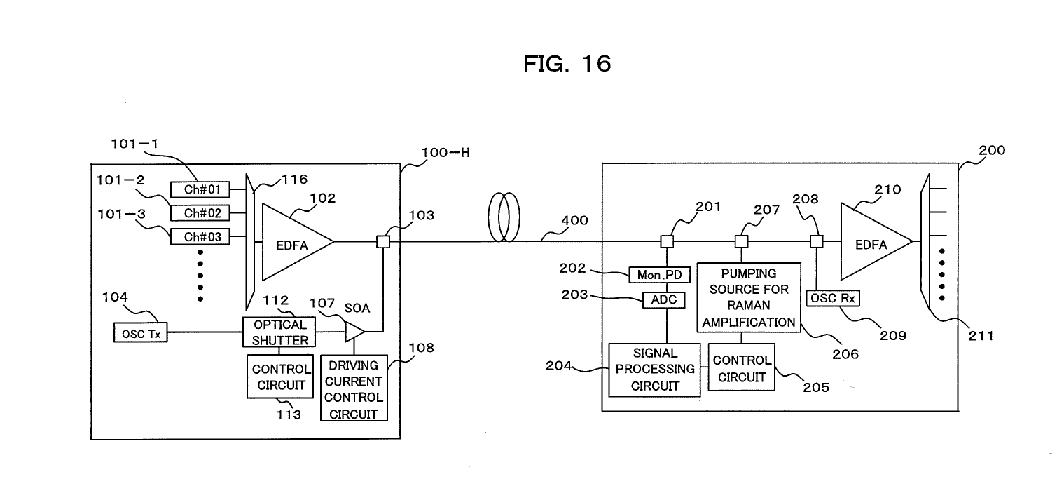

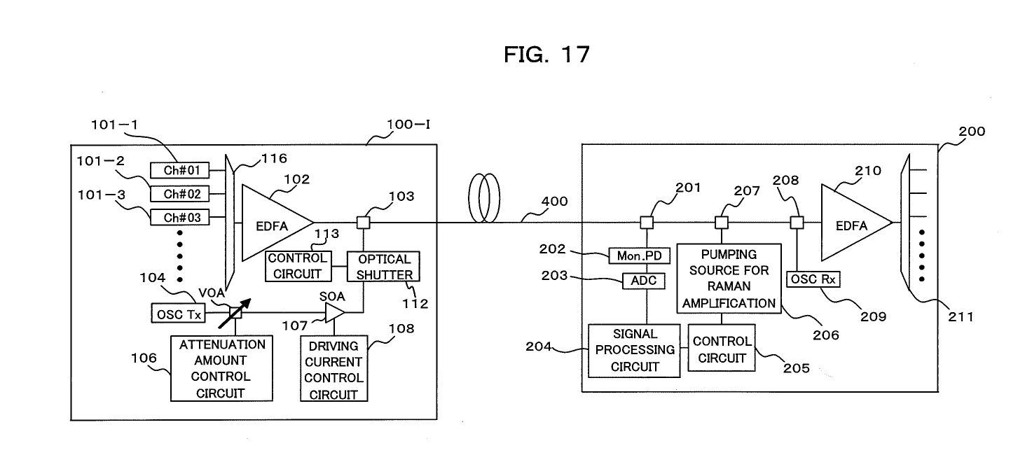

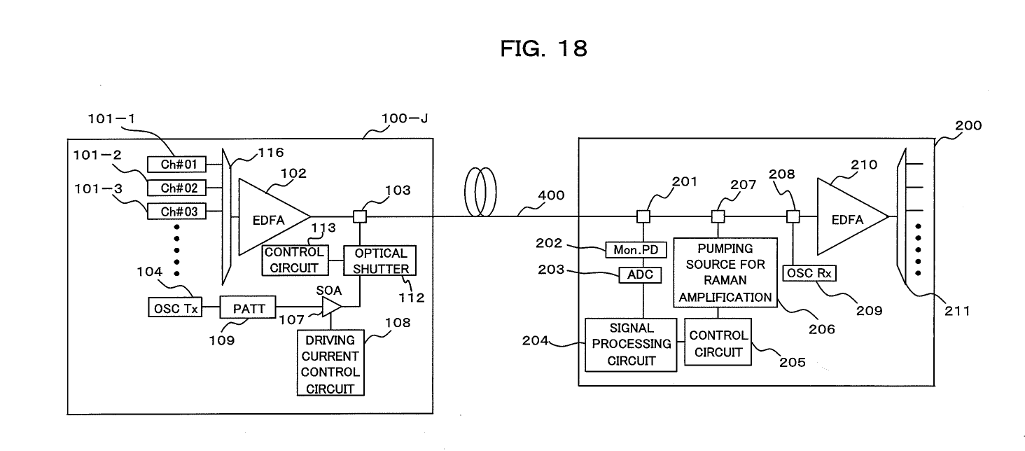

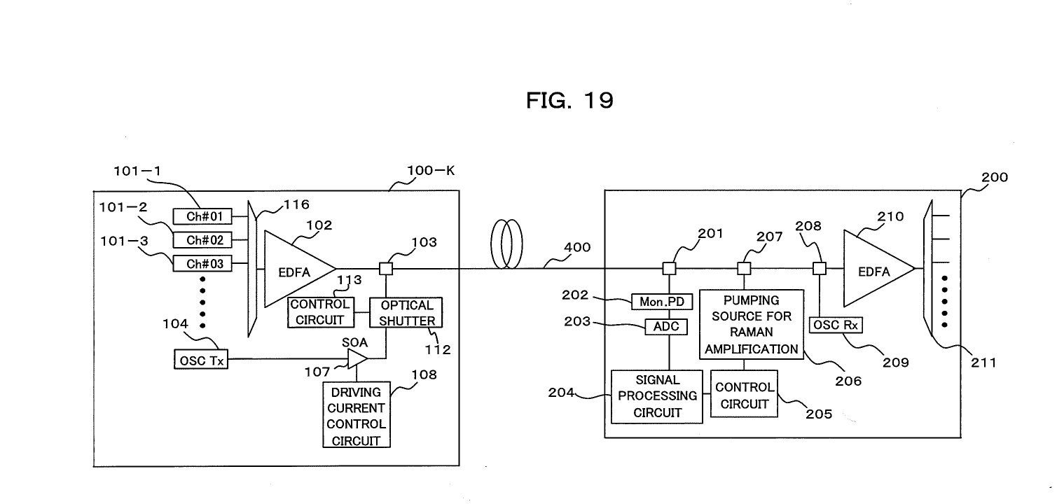

Instead of the optical transmitting stations 100, 100-A and 100-B illustrated in FIGS. 1, 6 and 7, optical transmitting stations 100-F, 100-G, 100-H, 100-I, 100-J and 100-K illustrated in FIGS. 14 to 19 are employable. Each of the optical transmitting stations 100-F, 100-G and 100-H has an optical shutter 112 and a control circuit 113 in the preceding stage of the SOA 107 in the structure of the optical transmitting station 100, 100-A or 100-B. Each of the optical transmitting station 100-I, 100-J and 100-K has an optical shutter 112 and a control circuit 113 between the SOA 107 and the optical coupler 103 in the structure of the optical transmitting station 100, 100-A or 100-B. Incidentally, the remaining part of the configuration of the optical transmitting stations 100-F, 100-G, 100-H, and the remaining part of the configuration of the optical transmitting stations 100-I, 100-J and 100-K are similar to those of the optical transmitting stations 100, 100-A and 100-B, respectively, and the configurations of the EDFAs 102, the optical transmission line 400 and the optical receiving station 200 are similar to those illustrated in FIG. 1.

Each of the optical transmitting stations 100-F, 100-G, 100-H, 100-I, 100-J and 100-K according to this example controls the attenuation amount at the VOA 105 and the amplification gain of the SOA 107 to be constant, and periodically passes or shuts the OSC signal at the frequency f_{pc} by means of the optical shutter 112 (switches to pass or shut at the frequency f_{pc}) to generate the apparatus starting signal.

The optical shutter (passing/shutting unit) 112 passes or shuts off the OSC signal at the frequency f_{osc} generated by the OSC signal transmitter 104. The operation of the optical shutter 112 can be controlled by the control circuit 113, for example.

The control circuit 113 controls the passing/shutting operation of the optical shutter 112. The control circuit (passing/shutting controller) 113 in this example changes a cycle, in which the driving current to be given to the optical shutter 112 is supplied or stopped, at the second bit rate (frequency f_{pc}) lower than the first bit rate (frequency f_{osc}) of the OSC signal. Whereby, the OSC signal, on which control information has been superposed as components of the frequency f_{pc} used to start the optical receiving station 200, is outputted from the optical shutter 112.

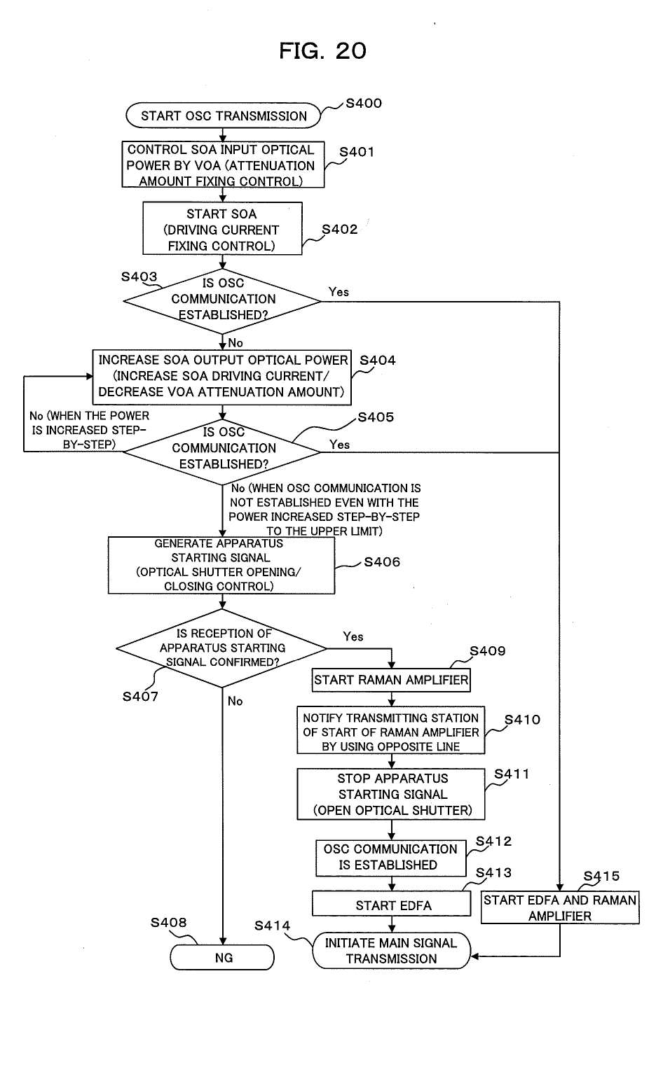

Next, an example of the operation (starting method) of the above WDM transmission system will be described with reference to FIG. 20.

In the optical transmitting station 100-F, 100-G, 100-H, 100-I, 100-J or 100-K, the OSC signal transmitter 104 starts generation and transmission of the OSC signal at the frequency f_{osc} (step S400).

The VOA 105 and the attenuation amount control circuit 106 perform a control to attenuate the OSC signal so that the optical power (level) of the OSC signal falls within an allowable range of the input optical level of the SOA 107 and the input optical power level to the SOA 107 is constant (step S401).

The driving current control circuit 108 controls the driving current to be given to the SOA 107 to a constant level (step S402), and controls the amplification gain at the SOA 107 to a constant value.

The SOA 107 acts as a loss medium when not given a driving current at a predetermined level or more. For this, the driving current control circuit 108 gives the driving current to the SOA 107 so that the output optical power level from the SOA 107 is at the almost same level as the output optical power level from the OSC signal transmitter 104.

The OSC signal amplified by the SOA 107 is inserted to the optical transmission line 400 by the optical coupler 103, and transmitted to the optical receiving station 200. The optical receiving station 200 determines whether the OSC signal receiver 209 receives and identifies the OSC signal (that is, whether the OSC communication is established) (step S403).

When it is determined as a result that the OSC communication has been established (Yes route at step S403), the optical receiving station 200 starts the Raman pumping source 206 and the optical amplifier (EDFA) 210 (step S415).

Because of the establishment of the OSC communication in the opposite line, the optical transmitting station 100-F, 100-G, 100-H, 100-I, 100-J or 100-K starts the optical amplifier (EDFA) 102 to initiate transmission of the main signal light (WDM light) (step S414).

On the other hand, when the OSC communication is not established (No route at step S403), the optical transmitting station 100-F, 100-G, 100-H, 100-I, 100-J or 100-K performs a control to increase the output optical power level of the OSC signal outputted from the SOA 107 (step S404). This control can be done by increasing the driving current given to the SOA 107 from the driving current control circuit 108, or decreasing the attenuation amount at the VOA 105 by the attenuation amount control circuit 106, or both. On such occasion, the output optical power level may be increased at a time to a predetermined value (for example, upper limit value) or increased step-by-step to the upper limit value (No route (in the leftward direction on the paper) at step S405).

The optical transmitting station 100-F, 100-G, 100-H, 100-I, 100-J or 100-K determines whether the OSC communication with the optical receiving station 200 is established with the help of an increase in the output optical power of the SOA 107 (step S405).

When the OSC communication is established (Yes route at step S405), the optical receiving station 200 starts the Raman pumping source 206 and the optical amplifier (EDFA) 210 (step S415). Because of the establishment of the OSC communication in the opposite line, the optical transmitting station 100-F, 100-G, 100-H, 100-I, 100-J or 100-K starts the optical amplifier (EDFA) 102 to initiate transmission of the main signal light (WDM light) (step S414).

On the other hand, when the OSC communication is not yet established even though the output optical power level of the SOA 107 has reached the upper limit value (No route (in the downward direction on the paper) at step S405), the optical transmitting station 100-F, 100-G, 100-H, 100-I, 100-J or 100-K switches the passing/shutting operation (opening/closing operation) of the optical shutter 112 at the frequency f_{pc} lower than the frequency f_{osc} to change the power level of the OSC signal at the frequency f_{pc}, thereby generating the apparatus starting signal (step S406).

The OSC signal on which the apparatus starting signal has been superposed is inserted to the optical transmission line 400 by the optical coupler 103, and transmitted to the optical receiving station 200. In the optical receiving station 200, the PD for optical monitor 202, the ADC 203 and the signal processing circuit 204 together monitor whether the apparatus starting apparatus is received and identified (step S407).

When the signal processing circuit 204 does not identify reception of the apparatus starting signal (No route at step S407), the optical receiving station 200 does not start the optical amplifier 210 and the Raman pumping source 206 (step S408).

On the other hand, when the signal processing circuit 204 identifies reception of the apparatus starting signal (Yes route at step S407), the optical receiving station 200 starts the Raman pumping source 206 by means of the control circuit 205 (step S409). The optical receiving station 200 notifies the optical transmitting station 100-F, 100-G, 100-H, 100-I, 100-J or 100-K of this start with the use of the opposite line (step S410). This notification of the start of the Raman pumping source 206 also means a notification to the optical transmitting station 100-F, 100-G, 100-H, 100-I, 100-J or 100-K that reception of the apparatus starting signal has been confirmed by the optical receiving station 200 (signal processing circuit 204).

The optical transmitting station 100-F, 100-G, 100-H, 100-I, 100-J or 100-K having received the above notification from the optical transmitting station 200 performs a control to make the optical shutter 112 keep performing the passing (opening) operation, thereby to stop superposing the apparatus starting signal on the OSC signal (that is, stop generation of the apparatus starting signal) (step S411).

Thereafter, with the help of the start of the Raman pumping source 206, the optical receiving station 200 comes to be able to receive and identify the OSC signal from the optical transmitting station 100-F, 100-G, 100-H, 100-I, 100-J or 100-K by means of the OSC signal receiver 209, and the OSC communication with the optical transmitting station 100-F, 100-G, 100-H, 100-I, 100-J or 100-K is established (step S412). When the OSC communication is established, the optical receiving station 200 starts the optical amplifier (EDFA) 210.

When the OSC communication in the opposite line is established, the optical transmitting station 100-F, 100-G, 100-H, 100-I, 100-J or 100-K starts the EDFA 102 after confirming the establishment (step S413), and initiates transmission of the main signal light (WDM light) (step S414).

As above, this modification can provide the same working effects as the above-described embodiments.

(2.8) Fifth Modification

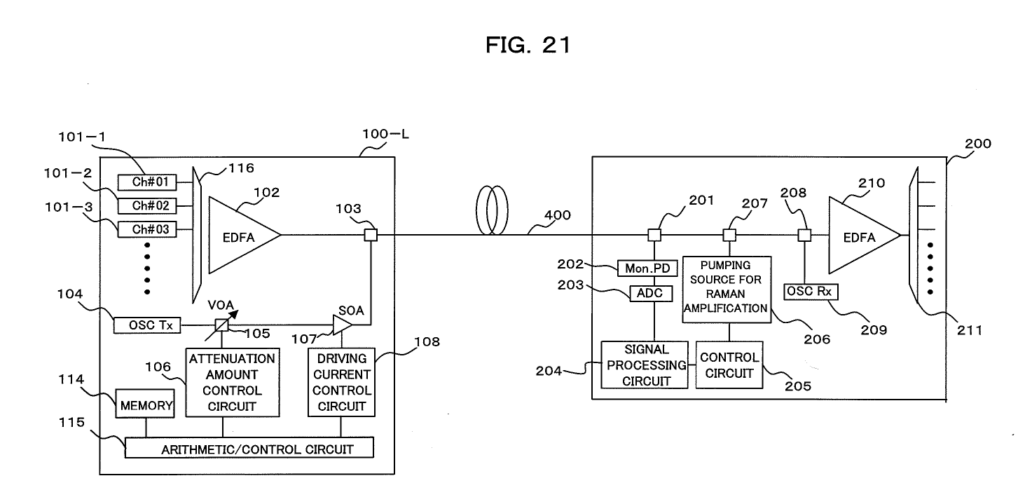

Instead of the optical transmitting station 100 illustrated in FIG. 1, an optical transmitting station 100-L illustrated in FIG. 21 is employable.

The optical transmitting station 100-L illustrated in FIG. 21 has a memory 114 and an arithmetic/control circuit 115 in addition to the configuration of the optical transmitting station 100. Incidentally, the remaining part of the configuration of the optical transmitting station 100-L is the same as that of the optical transmitting station 100, and the configurations of the EDFAs 102, the optical transmission line 400 and the optical receiving station 200 are the same as those illustrated in FIG. 1.

The memory 114 retains a table in which a transmission section distance between the optical transmitting station 100-L and the optical receiving station 200 is beforehand associated with a bit rate (frequency) value suited to the transmission section distance. Contents of the table may be prepared and updated by a terminal for system control (not illustrated) or the user.

The arithmetic/control circuit 115 controls the attenuation amount control circuit 106, or the driving current control circuit 108, or both. The arithmetic/control circuit 115 in this example changes the attenuation amount of the VOA 105 and the amplification gain of the SOA 107 at a bit rate suited to the transmission section distance, on the basis of administration information (the number of wavelengths, transmission section distance, etc.) on the WDM system beforehand set by the user or the like and the contents of the table retained by the memory 114.

On such occasion, the arithmetic/control circuit (frequency controller) 115 in this example performs a control to set the frequency f_{pc} to a lower value as the transmission section distance between the optical transmitting station 100-L and the optical receiving station 200 becomes longer.

The VOA 105 or the SOA 107 in this example changes the attenuation amount or the amplification gain at a bit rate (frequency f_{pc}) controlled by the arithmetic/control circuit 115 to generate the apparatus starting signal.

Whereby, the optical transmitting station 100-L can further improve the probability that the OSC signal can reach the receiving station 200 even when the transmission section distance is long.

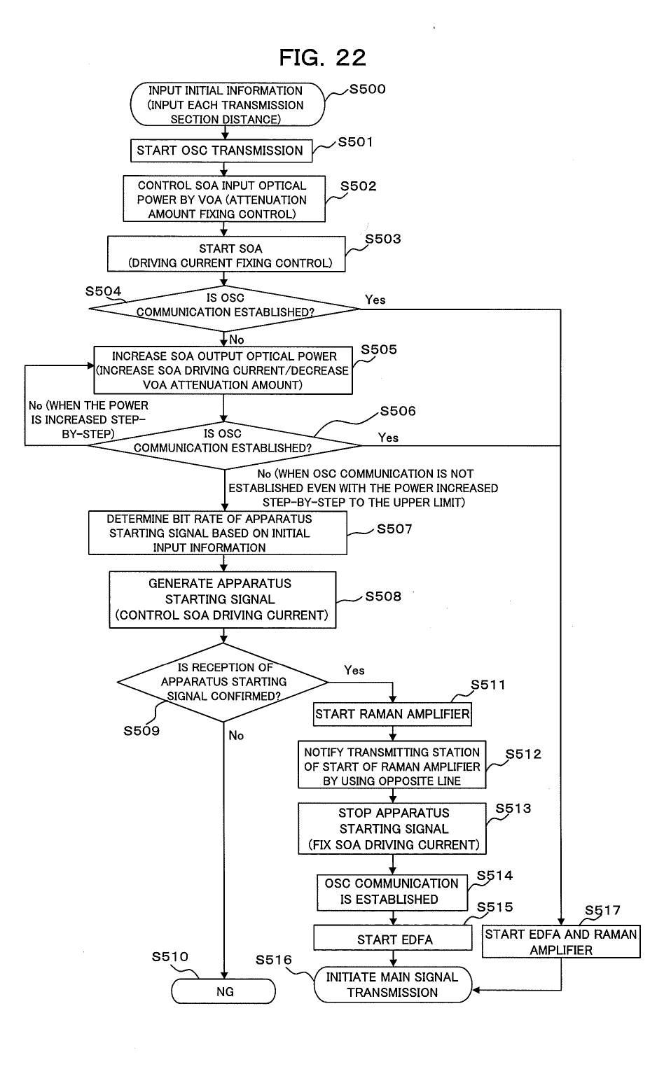

Next, an example of the operation (starting method) of the above WDM transmission system will be described with reference to FIG. 22.

In the optical transmitting station 100-L, the user or the like sets initial information (administration information) such as a transmission section distance between the optical transmitting station 100-L and the optical receiving station 200, etc. (step S500). The OSC signal transmitter 104 starts generation and transmission of the OSC signal at the frequency f_{osc} (step S501).

The VOA 105 and the attenuation amount control circuit 106 perform controls on the OSC signal so that the optical power (level) of the OSC signal falls within an allowable range of the input optical level of the SOA 107 and the input optical power level to the SOA 107 is constant (step S502).

The driving current control circuit 108 controls the driving current to be given to the SOA 107 to a constant level (step S503), and controls the amplification gain at the SOA 107 to a constant value.

The SOA 107 acts as a loss medium when not given the driving current at a predetermined level or more. For this, the driving current control circuit 108 gives the driving current to the SOA 107 so that the output optical power level from the SOA 107 is at almost the same level as the output optical power level from the OSC signal transmitter 104.

The OSC signal amplified by the SOA 107 is inserted to the optical transmission line 400 by the optical coupler 103, and transmitted to the optical receiving station 200. The optical receiving station 200 determines whether the OSC signal receiver 209 receives and identifies the OSC signal (that is, whether the OSC communication is established) (step S504).

When it is determined as a result that the OSC communication has been established (Yes route at step S504), the optical receiving station 200 starts the Raman pumping source 206 and the optical amplifier (EDFA) 210 (step S517).

Because of establishment of the OSC communication in the opposite line, the optical transmitting station 100-L starts the optical amplifier (EDFA) 102 to initiate transmission of the main signal light (WDM light) (step S516).

On the other hand, when the OSC communication is not established (No route at step S504), the optical transmitting station 100-L performs a control to increase the output optical power level of the OSC signal outputted from the SOA 107 (step S505). This control can be done, for example, by increasing the driving current to be given to the SOA 107 from the driving current control circuit 108, or decreasing the attenuation amount at the VOA 105 by the attenuation amount control circuit 106, or both. On such occasion, the output optical power level of the SOA 107 may be increased at a time to a predetermined value (for example, upper limit value), or may be increased step-by-step to the upper limit value (No route (in the leftward direction on the paper) at step S506).

The optical transmitting station 100-L determines whether the OSC communication with the optical receiving station 200 is established with the help of an increase in the output optical level of the SOA (step S506).

When the OSC communication is established (Yes route at step S506), the optical receiving station 200 starts the Raman pumping source 206 and the optical amplifier (EDFA) 210 (step S517). Because of establishment of the OSC communication in the opposite line, the optical transmitting station 100-L starts the optical amplifier (EDFA) 102 to initiate transmission of the main signal light (WDM light) (step S516).

On the other hand, when the OSC communication is not established even though the output optical power level of the SOA 107 has reached the upper limit value (No route (in the downward direction on the paper) at step S506), the optical transmitting station 100-L determines a bit rate (frequency f_{pc}) of the apparatus starting signal suited to the transmission section distance by means of the memory 114 and the arithmetic/control circuit 115 (step S507).

The optical transmitting station 100-L changes the amplification gain of the SOA 107 at the determined bit rate (frequency f_{pc}) by means of the driving current control circuit 108 to change the power level of the OSC signal at the frequency f_{pc}, thereby generating the apparatus starting signal having the frequency f_{pc} (step S508).

The OSC signal on which the apparatus starting signal has been superposed is inserted to the optical transmission line 400 by the optical coupler 103, and transmitted to the optical receiving station 200. In the optical receiving station 200, the PD for optical monitor 202, the ADC 203 and the signal processing circuit 204 together monitor whether the apparatus starting signal is received and identified (step S509).

When the signal processing circuit 204 does not identify reception of the apparatus starting signal (No route at step S509), the optical receiving station 200 does not start the optical amplifier 210 and the Raman pumping source 206 (step S510).

On the other hand, when the signal processing circuit 204 identifies reception of the apparatus starting signal (Yes route at step S509) the optical receiving station 200 starts the Raman pumping source 206 by means of the control circuit 205 (step S511). The optical receiving station 200 notifies the optical transmitting station 100-L of the start with the use of the opposite line (step S512). This notification of start of the Raman pumping source 206 also signifies a notification to the optical transmitting station 100-L that reception of the apparatus starting signal has been confirmed by the optical receiving station 200 (signal processing circuit 204).

In the optical transmitting station 100-L having received the notification from the optical receiving station 200, the driving current control circuit 108 controls the driving current to be given to the SOA to be constant to control the amplification gain at the SOA 107 to be constant, thereby to stop superposing the apparatus starting signal onto the OSC signal (that is, stop generation of the apparatus starting signal) (step S513).

Thereafter, with the help of start of the Raman pumping source 206, the optical receiving station 200 comes to be able to receive and identify the OSC signal from the optical transmitting station 100-L by the OSC signal receiver 209, hence the OSC communication with the optical transmitting station 100-L is established (step S514). When the OSC communication is established, the optical receiving station 200 starts the optical amplifier (EDFA) 210.

When the OSC communication in the opposite line is established, the optical transmitting station 100-L starts the EDFA 102 after confirming establishment of the OSC communication in the opposite line (step S515), and initiates transmission of the main signal light (WDM light) (step S516).

As above, the optical transmitting station 100-L can further improve the probability that the OSC signal can reach the optical receiving station 200 even in a long-distance transmission section.

In the above example of the operation, the amplification gain of the SOA 107 is changed at the frequency f_{pc} to generate the apparatus starting signal. Alternatively, the apparatus starting signal may be generated in any method in the above-described modifications, as a matter of course.

(2.9) Sixth Modification

In the above example, the bit rate of the apparatus starting signal is determined on the basis of a transmission section distance between the optical transmitting station 100-L and the optical receiving station 200. Alternatively, the bit rate of the apparatus starting signal may be determined on the basis of the transmission section distance and a transmission level of the OSC signal (output optical power level of the OSC signal transmitter 104).

A WDM transmission system in this example has the same configuration as the WDM transmission system illustrated in FIG. 21.

The arithmetic/control circuit (frequency controller) 115 in this example determines the frequency f_{pc} according to administration information (the number of wavelengths, transmission section distance, etc.) on the WDM system beforehand set by the user or the like and an output optical power level (transmission level) of the OSC signal transmitter 104. The arithmetic/control circuit 115 in this example calculates (computes) a received light level estimation value of the OSC signal at the optical receiving station 200, and controls to set the frequency f_{pc} to a lower value as the received light level estimation value becomes smaller.

The VOA 105 or the SOA 107 in this example changes the attenuation amount or the amplification gain at a bit rate (frequency f_{pc}) controlled by the arithmetic/control circuit 115 to generate the apparatus starting signal.

Whereby, the optical transmitting station 100-L can further improve the probability that the OSC signal can reach the optical receiving station 200 even when the transmission section distance is long.

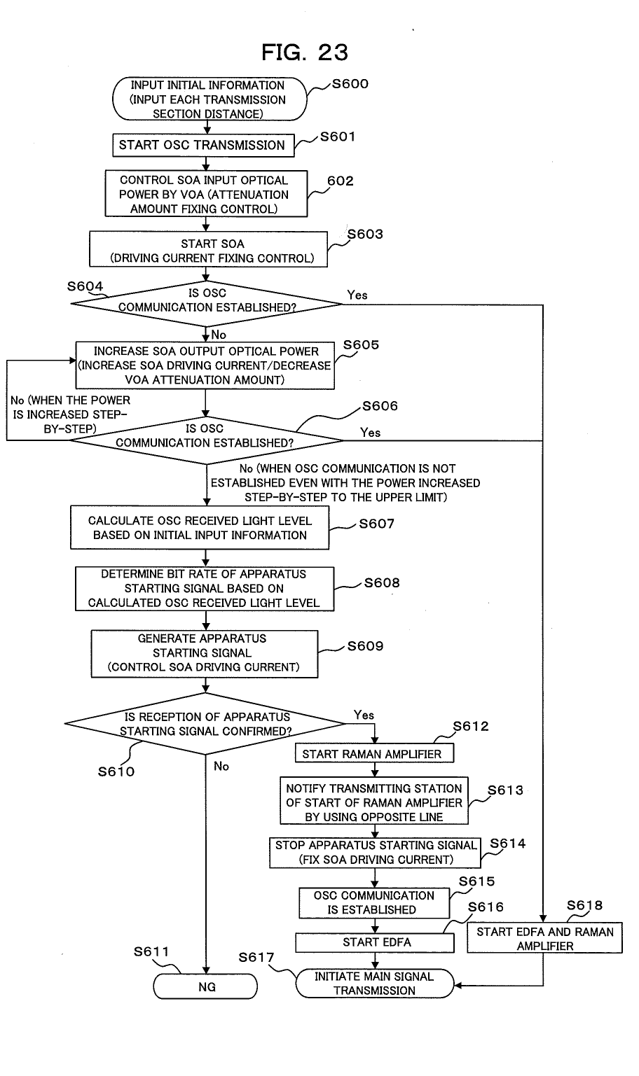

Next, an example of the operation (starting method) of the above WDM transmission system will be described with reference to FIG. 23.

In the optical transmitting station 100-L, the user or the like sets initial information (administration information) such as a transmission section distance between the optical transmitting station 100-L and the optical receiving station 200, etc. (step S600). The OSC signal transmitter 104 starts generation and transmission of the OSC signal at frequency f_{osc} (step S601).

The VOA 105 and the attenuation amount control circuit 106 perform controls to attenuate the OSC signal so that the optical power (level) of the OSC signal falls within an allowable range of the input optical level of the SOA 107 and the input optical power level to the SOA is constant (step S602).

The driving current control circuit 108 controls the driving current to be given to the SOA 107 to a constant level (step S603), and controls the amplification gain at the SOA 107 to a constant value.

The SOA 107 acts as a loss medium when not given a driving current at a predetermine level or more. For this, the driving current control circuit 108 gives the driving current to the SOA 107 so that the output optical power level from the SOA 107 is at almost the same level as the output optical power level from the OSC signal transmitter 104.

The OSC signal amplified by the SOA 107 is inserted to the optical transmission line 400 by the optical coupler 103, and transmitted to the optical receiving station 200. The optical receiving station 200 determines whether the OSC signal receiver 209 receives and identifies the OSC signal (that is, the OSC communication is established) (step S604).

When it is determined as a result that the OSC communication has been established (Yes route at step S604), the optical receiving station 200 starts the Raman pumping source 206 and the optical amplifier (EDFA) 210 (step S618).

Because of establishment of the OSC communication in the opposite line, the optical transmitting station 100-L starts the optical amplifier (EDFA) 102 to initiate transmission of the main signal light (WDM light) (Step S617).

On the other hand, when the OSC communication is not established (No route at step S604), the optical transmitting station 100-L performs a control to increase the output optical power level of the OSC signal outputted from the SOA 107 (step S605). This control can be done by increasing the driving current to be given to the SOA 107 from the driving current control circuit 108, or decreasing the attenuation amount of the VOA 105, or both. On such occasion, the output optical power level may be increased at a time to a predetermined value (upper limit value, for example), or may be increased step-by-step to the upper limit value (No route (in the leftward direction on the paper) at step S606).

The optical transmitting station 100-L determines whether the OSC communication with the optical receiving station 200 is established with the help of an increase in the output optical power level of the SOA 107 (step S606).

When the OSC communication is established (Yes route at step S606), the optical receiving station 200 starts the Raman pumping source 206 and the optical amplifier (EDFA) 210 (step S618). Because of establishment of the OSC communication in the opposite line, the optical transmitting station 100-L starts the optical amplifier (EDFA) 102 to initiate transmission of the main signal light (WDM light) (step S617).

On the other hand, when the OSC communication is not established even though the output optical power has reached the upper limit value (No route (in the downward direction on the paper) at step S606), in the optical transmitting station 100-L, the memory 114 and the arithmetic/control circuit 115 calculate a received light level (estimated) value of the OSC signal at the optical receiving station 200 on the basis of the transmission section distance and the transmission level of the OSC signal transmitter 104 (step S607).

The optical transmitting station 100-L determines a bit rate (frequency) of the apparatus starting signal according to the calculated received light level (step S608). The driving current control circuit 108 changes the amplification gain of the SOA 107 at the determined bit rate (frequency f_{pc}) to change the power level of the OSC signal, whereby the apparatus starting signal at the frequency f_{pc} is generated (step S609).

The OSC signal on which the apparatus starting signal has been superposed is inserted to the optical transmission line 400 by the optical coupler 103, and transmitted to the optical receiving station 200. In the optical receiving station 200, the PD for optical monitor 202, the ADC 203 and the signal processing circuit 204 together monitor whether the apparatus starting signal is received and identified (step S610).

When the signal processing circuit 204 does not identify reception of the apparatus starting signal (No route at step S610), the optical receiving station 200 does not perform a control to start the optical amplifier 210 and the Raman pumping source 206 (step S611).

On the other hand, when the signal processing circuit 204 identifies reception of the apparatus starting signal (Yes route at step S610), the optical receiving station 200 starts the Raman pumping source 206 by means of the control circuit 205 (step S612). The optical receiving station 200 notifies the optical transmitting station 100-L of this start, using the opposite line (step S613). This notification of start of the Raman pumping source 206 is also a notification to the optical transmitting station 100-L that the optical receiving station 200 (signal processing circuit 204) has confirmed reception of the apparatus starting signal.

In the optical transmitting station 100-L having received the above notification from the optical receiving station 200, the driving current control circuit 108 controls the driving current to be given to the SOA 107 to be constant to control the amplification gain at the SOA 107 to be constant, thereby to stop superposing the apparatus starting signal onto the OSC signal (that is, stop generation of the apparatus starting signal) (step S614).

Thereafter, owing to start of the Raman pumping source, in the optical receiving station 200, the OSC signal receiver 209 comes to be able to receive and identify the OSC signal from the optical transmitting station 100-L, hence the OSC communication with the optical transmitting station 100-L is established (step S615). When the OSC communication is established, the optical receiving station 200 starts the optical amplifier (EDFA) 210.

When the OSC communication in the opposite line is established, the optical transmitting station 100-L starts the EDFA 102 after confirming establishment of the OSC communication in the opposite line (step S616), and initiates transmission of the main signal light (WDM light) (step S617).

Whereby, the optical transmitting station 100-L can further improve the probability that the OSC signal can reach the optical receiving station 200 even when the transmission section distance is long.

In the above example of the operation, the amplification gain at the SOA 107 is changed at the frequency f_{pc} to generate the apparatus starting signal. Alternatively, the apparatus starting signal may be generated in any method described in the above-noted examples.

(2.10) Seventh Modification

In the above examples, the optical transmitting stations 100, 100-A to 100-L may perform a control to decrease, step-by-step, the bit rate (frequency) of the apparatus starting signal until the optical receiving station 200 detects reception (identification) of the apparatus starting signal having the frequency f_{pc} generated in the above methods.

More concretely, when not receiving a notification (response) from the optical receiving station 200 that the optical receiving station 200 has identified the apparatus starting signal within a predetermined time period after the apparatus starting signal generated in any one of the above methods is transmitted to the optical receiving station, each of the optical transmitting station 100, 100-A to 100-L determines that the apparatus starting signal cannot reach the optical receiving station 200 if the bit rate remains unchanged. Until receiving the response, each of the control circuits (frequency decreasing control circuit) 104, 106, 108, 110, 113 and 115 decreases, step-by-step, the bit rate of the apparatus starting signal.

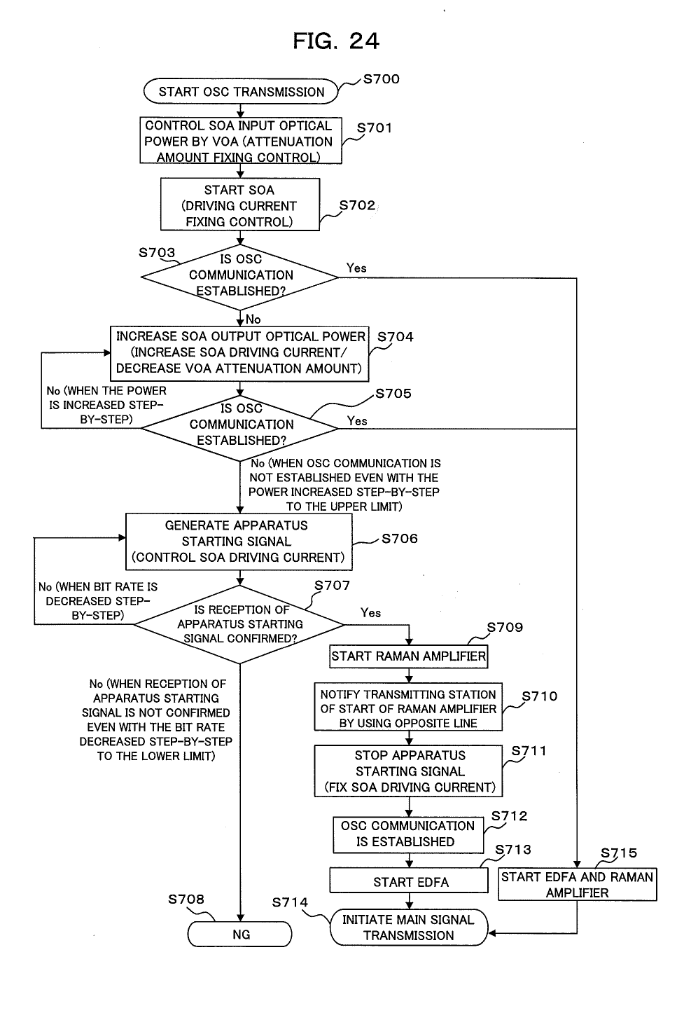

Next, an example of the operation of the above WDM transmission system will be described with reference to FIG. 24.

In the optical transmitting station 100, 100-A, 100-B, . . . , or 100-L, the OSC signal transmitter 104 starts generation and transmission of the OSC signal at the frequency f_{osc} (step S700).

The VOA 105 and the attenuation amount control circuit 106 performs controls to attenuate the OSC signal so that the optical power (level) of the OSC signal falls within an allowable range of the input optical level of the SOA 107 and the input optical power level to the SOA 107 is constant (step S701).

The driving current control circuit 108 controls the driving current to be given to the SOA 107 to a constant level (step S702) to control the amplification gain at the SOA 107 to a constant value.

The SOA 107 acts as a loss medium when not given a driving current at a predetermined level or more. For this, the driving current control circuit 108 gives the driving current to the SOA 107 so that the output optical power level from the SOA 107 is at almost the same level as the output optical power level from the OSC signal transmitter 104.

The OSC signal amplified by the SOA 107 is inserted to the optical transmission line 400 by the optical coupler 103, and transmitted to the optical receiving station 200. The optical receiving station 200 determines whether the OSC signal receiver 209 receives and identifies the OSC signal (that is, whether the OSC communication is established) (step S703).

When it is determined as a result that the OSC communication has been established (Yes route at step S703), the optical receiving station 200 starts the Raman pumping source 206 and the optical amplifier (EDFA) 210 (step S715).

Because of establishment of the OSC communication in the opposite line, the optical transmitting station 100, 100-A, 100-B, . . . , or 100-L starts the optical amplifier (EDFA) 102 to initiate transmission of the main signal light (WDM light) (step S714).

On the other hand, when the OSC communication is not established (No route at step S703), the optical transmitting station 100, 100-A, 100-B, . . . , or 100-L performs a control to increase the output optical power level of the OSC signal outputted from the SOA 107 (step S704). This control can be done by increasing the driving current to be given to the SOA 107 from the driving current control circuit 108, or decreasing the attenuation amount of the VOA 105 by the attenuation amount control circuit 106, or both, for example. On such occasion, the output optical power level of the SOA 107 may be increased at a time to a predetermined value (upper limit value, for example), or may be increased step-by-step to the upper limit value (No route (on the leftward direction on the paper) at step S705).

The optical transmitting station 100, 100-A, 100-B, . . . , or 100-L determines whether the OSC communication with the optical receiving station 200 is established with the help of an increase in the output optical power level of the SOA 107 (step S705).

When the OSC communication is established (Yes route at step S705), the optical receiving station 200 starts the Raman pumping source 206 and the optical amplifier (EDFA) 210 (step S715). Because of establishment of the OSC communication in the opposite line, the optical transmitting station 100, 100-A, 100-B, . . . , or 100-L starts the optical amplifier (EDFA) 102 to initiate transmission of the main signal light (WDM light) (step S714).

On the other hand, when the OSC communication is not established even though the output optical power level has reached the upper limit value (No route (in the downward direction on the paper) at step S705), the optical transmitting station 100, 100-A, 100-B, . . . , or 100-L performs a control on the driving current to be given to the SOA 107 by means of the driving current control circuit 108 as described hereinbefore with reference to FIG. 2 to change the amplification gain at the SOA 107 at the frequency f_{pc} lower than the frequency f_{osc}, thereby changing the power level of the OSC signal at the frequency f_{pc} to generate the apparatus starting signal having the frequency f_{pc} (step S706). The OSC signal on which the apparatus starting signal has been superposed is inserted to the optical transmission line 400 by the optical coupler 103, and transmitted to the optical receiving station 200. In the optical receiving station 200, the PD for optical monitor 202, the ADC 203 and the signal processing circuit 204 together monitor whether the apparatus starting signal is received and identified (step S707). On such occasion, the optical transmitting station 100, 100-A, 100-B, . . . , or 100-L performs a control to decrease step-by-step the bit rate (frequency) of the apparatus starting signal to the lower limit value until the optical receiving station 200 confirms reception (identification) of the apparatus starting signal having the frequency f_{pc} (No route (in the leftward direction on the paper) at step S707).

When the signal processing circuit 204 does not identify reception of the apparatus starting signal even though the frequency of the apparatus starting signal has reached the lower limit value (No route (in the downward direction on the paper) at step S707), the optical receiving station 200 does not perform a control to start the optical amplifier 210 and the Raman pumping source 206 (step S708).

On the other hand, when the signal processing circuit 204 identifies reception of the apparatus starting signal (Yes route at step S707), in the optical receiving station 200, the control circuit 205 starts the Raman pumping source 206 (step S709). The optical receiving station 200 notifies the optical transmitting station 100, 100-A, 100-B, . . . , or 100-L of this start by using the opposite line (step S710). The notification of start of the Raman pumping source 206 is also a notification to the optical transmitting station 100, 100-A, 100-B, . . . , or 100-L that the optical receiving station 200 (signal processing circuit 204) has confirmed reception of the apparatus starting signal.

In the optical transmitting station 100, 100-A, 100-B, . . . , or 100-L having received the notification from the optical receiving station 200, the driving current control circuit 108 controls the driving current to be given to the SOA 107 to be constant to control the amplification gain at the SOA 107 to be constant, thereby to stop superposing the apparatus starting signal onto the OSC signal (that is, stop generation of the apparatus starting signal) (step S711).

Thereafter, with the help of start of the Raman pumping source 206, the optical receiving apparatus 200 comes to be able to receive and identify the OSC signal from the optical transmitting station 100, 100-A, 100-B, . . . , or 100-L by the OSC signal receiver 209, hence the OSC communication with the optical transmitting station 100, 100-A, 100-B, . . . , or 100-L is established (step S712). When the OSC communication is established, the optical receiving station 200 starts the optical amplifier (EDFA) 210.

When the OSC communication is established in the opposite line, the optical transmitting station 100, 100-A, 100-B, . . . , or 100-L starts the EDFA 102 after confirming establishment of the OSC communication in the opposite line (step S713), and initiates transmission of the main signal light (WDM light) (step S714).

As above, the optical transmitting stations 100, 100-A to 100-L can further improve the probability that the OSC signal can reach the optical receiving station 200 even when the transmission section distance is long.

In the above example, the apparatus starting signal is generated by changing the amplification gain of the SOA 107 at the frequency f_{pc}. Alternatively, the apparatus starting signal may be generated in the method described in any one of the above examples.

### [3] Others

The processes in the optical transmitting stations 100 and 100-A to 100-L and the optical receiving station 200 may be adopted or eliminated as required, or may be suitably combined.

In the examples of the operation of the WDM transmission system, the connection is confirmed with the use of the apparatus starting signal after confirmation of the connection is tried with the use of the OSC signal. Alternatively, the connection confirmation with the use of the apparatus starting signal may be carried out first. By doing so, it becomes possible to decrease the time required to confirm the connection in the transmission section, which makes it possible to shorten the time required to start the WDM system, as a result.

In the examples of the operation, the EDFAs 102 and 210 are started, after the connection is confirmed with the use of the apparatus starting signal and establishment of the OSC communication is further confirmed. Alternatively, the EDFAs 102 and 210 may be started when the connection is confirmed with the use of the apparatus starting signal.

In the examples of the operation, the optical receiving station 200 notifies the optical transmitting station 100 of start of the Raman pumping source 206 by using the opposite line after confirming reception of the apparatus starting signal. Alternatively, the optical receiving station 200 may notify the optical transmitting station 100 of confirmation of reception of the OSC signal when the OSC signal receiver 209 confirms reception of the OSC signal. By doing so, the optical transmitting station 100 can confirm establishment of the OSC communication through the above notification, which is helpful to shorten the time required to start the EDFA 102.

In the examples of the operation, the optical transmitting station 100 stops generating the apparatus starting signal after confirming the connection with the use of the apparatus starting signal. Alternatively, the optical receiving station 200 may stop the process relating to reception of the apparatus starting signal. By doing so, the above WDM transmission system can further reduce the electric power consumption.

In the above examples, the apparatus starting signal is superposed on the OSC signal. Alternatively, the apparatus starting signal (information) may be superposed on another signal light such as signal light in optical auxiliary channel (OAC), for example.

The above examples have been described by way of the WDM transmission system, for example. However, the above method may be applied to other transmission systems.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) has(have) been described in detail, it should be understood that the various changes substitutions, and alterations could be made hereto without departing from the spirit and scope of the invention.

What is claimed is:

1. An optical transmission apparatus transmitting signal light through an optical transmission line to an optical reception apparatus, the optical transmission apparatus comprising:
a transmitter that transmits control signal light having a first frequency to the optical transmission line; and
a controller that changes a power level of the control signal light at a second frequency lower than the first frequency.

2. The optical transmission apparatus according to claim 1, wherein the controller comprises:
an optical amplifier that amplifies the control signal light; and
a gain controller that changes a gain of the optical amplifier at the second frequency.

3. The optical transmission apparatus according to claim 1, wherein the controller comprises:
an optical attenuator that attenuates the power level of the control signal light; and
an attenuation amount controller that changes an attenuation amount of the optical attenuator at the second frequency.

4. The optical transmission apparatus according to claim 1, wherein the controller comprises:
a passing/shutting unit that passes or shuts the control signal light; and
a passing/shutting state controller that switches between a passing state and a shutting state in the passing/shutting unit at the second frequency.

5. The optical transmission apparatus according to claim 1, wherein the controller comprises:
a frequency controller that sets the second frequency to a lower value as a transmission distance between the optical transmission apparatus and the optical reception apparatus becomes longer.

6. The optical transmission apparatus according to claim 1, wherein the controller comprises:
a frequency controller that sets the second frequency according to a transmission distance between the optical transmission apparatus and the optical reception apparatus and a transmission level of the control signal light.

7. The optical transmission apparatus according to claim 1, wherein the controller comprises:
a frequency lowering controller that performs a control to lower the second frequency step-by-step until the optical reception apparatus detects that reception of signal light components of the second frequency is confirmed.

8. An optical reception apparatus receiving signal light from an optical transmission apparatus through an optical transmission line, the optical reception apparatus comprising:
a receiver that receives the signal light regenerated by changing a power level of control signal light having a first frequency at a second frequency lower than the first frequency in the optical transmission apparatus and transmitted from the optical transmission apparatus; and
a monitor that monitors whether signal light components of the second frequency are received by the receiver.

9. The optical reception apparatus according to claim 8, wherein the monitor comprises:
a system start processor that carries out a system start process when reception of the signal light components of the second frequency is confirmed as a result of monitoring by the monitor.

10. The optical reception apparatus according to claim 9, wherein the system start processor comprises:
a Raman pumping source controller that is disposed in the optical reception apparatus to start a Raman pumping source giving a Raman gain to the control signal light.

11. The optical reception apparatus according to claim 10, wherein the system start processor comprises:
a notifier that notifies the optical transmission apparatus of start of the Raman pumping source.

12. The optical reception apparatus according to claim 8, wherein the monitor comprises:
a light receiving device that receives input light from the optical transmission line; and
a sampler that samples an optical level of the input light received by the light receiving device at a frequency higher than the second frequency.

13. The optical reception apparatus according to claim 1, wherein the control signal light is signal light used to confirm connection between the optical transmission apparatus and the optical reception apparatus; and
signal light components of the second frequency are signal light components requiring the optical reception apparatus to perform a start process.

14. An optical transmission system comprising:
an optical transmission apparatus that transmits signal light through an optical transmission line;
an optical reception apparatus that receives the signal light from the optical transmission apparatus through the optical transmission line;
a transmitter that transmits control signal light having a first frequency to the optical transmission line;
a controller that changes a power level of the control signal light at a second frequency lower than the first frequency;
a receiver that receives the control signal light transmitted from the optical transmission apparatus; and
a monitor that monitors whether signal light components of the second frequency are received by the receiver.

15. A communication method in an optical transmission system comprising an optical transmission apparatus, an optical reception apparatus and an optical transmission line connecting the optical transmission apparatus to the optical reception apparatus, the communication method comprising the steps of:
changing a power level of control signal light having a first frequency at a second frequency lower than the first frequency in the optical transmission apparatus;
transmitting the control signal light whose power level has been changed to the optical reception apparatus from the optical transmission apparatus through the optical transmission line; and
monitoring in the optical reception apparatus whether signal light components of the second frequency are received from the optical transmission line.

16. The communication method in an optical transmission system according to claim 15, wherein a system start process is carried out in the optical reception apparatus when reception of the signal light components of the second frequency is confirmed as a result of the monitoring.

17. The communication method in an optical transmission system according to claim 16, wherein, when the system start process is carried out, a Raman pumping source disposed in the optical reception apparatus to give a Raman gain to the control signal light is started in the optical reception apparatus; and
start of the Raman pumping source is notified from the optical reception apparatus to the optical transmission apparatus.

18. The communication method in an optical transmission system according to claim 17, wherein, when the notification is received from the optical reception apparatus by the optical transmission apparatus, a change in the power level is discontinued to transmit the control signal light from the optical transmission apparatus to the optical transmission line.
